(19) United States
(12) Patent Application Publication
(10) Pub. No.: US 2013/0060708 A1
(43) Pub. Date: Mar. 7, 2013

(54) USER VERIFICATION FOR ELECTRONIC MONEY TRANSFERS

(71) Applicants: Ilya Oskolkov, Moscow (RU); Rodion Shishkov, St. Petersburg (RU)

(72) Inventors: Ilya Oskolkov, Moscow (RU); Rodion Shishkov, St. Petersburg (RU)

(73) Assignee: RAWLLIN INTERNATIONAL INC., Tortola (VG)

(21) Appl. No.: 13/226,362

(22) Filed: Sep. 6, 2011

(51) Int. Cl. G06Q 20/00; H04L 9/32

(52) U.S. Cl. 705/75; 705/42

(57) ABSTRACT

Techniques for efficient transfer of funds between parties using personal communication devices are presented. A sender can use a first communication device to transfer funds from an account associated with the sender to a recipient via a communication address associated with the recipient's second communication device even if the recipient is not registered with a financial service provider associated with the account of the sender, without requiring the recipient to travel to a physical office or present a physical personal identification to obtain the funds. A transfer fund request can include the recipient's communication address, and a fund transfer message, comprising a link that facilitates retrieving the funds, can be sent to the recipient's communication address, and the recipient can be validated based on the communication address and/or a validation code. When validated, the funds can be made available to the recipient via an account of the recipient.

### TECHNICAL FIELD

This disclosure relates generally to data communications, and more specifically to user verification in relation to electronic money transfers via a communication network.

### BACKGROUND

Occasionally an individual desires or needs to transfer monetary funds to another person, including instances where the other person is located far away from the individual thereby making it difficult for the individual to transfer the monetary funds to the other person. For many years, people have been able to “wire” monetary funds via communication networks. With recent improvements in communication technology, it has been possible to use communication devices, such as personal computers and mobile phones (e.g., smart phones), via the Internet, mobile communication networks and other communication technology, to transfer monetary funds.

For example, an individual can register a bank account online and can make payment on bills to creditors using a computer or mobile phone. As another example, using a computer or mobile phone, the individual also can transfer monetary funds from one bank account to another bank account (e.g., another bank account of the individual or another bank account of another person) so long as both of those bank accounts are online and the individual knows the account information of the receiving bank account. As still another example, an individual can use a communication device to transfer monetary funds from the individual's account associated with a financial services provider (e.g., a bank account or an online account with a financial services provider) to another person so long as both the individual or other person have registered with the financial services provider.

However, conventional systems and methods for transferring monetary funds have drawbacks. For instance, conventionally both the individual who is sending money and the other person receiving the money have to be registered with a financial entity, such as a financial services provider, in order for the individual and other person to be able to use their respective computers or mobile phones to perform the monetary transfer. Conventional money transfer businesses typically require an intended fund transfer recipient to show a valid personal identification having a picture image of the recipient (e.g., driver's license) and/or require the recipient to travel to a designated money-transfer-business office in order to obtain the transferred funds when the recipient is not registered with the money transfer business.

Today, there is no way to effectively manage electronic monetary transfers between an individual sending money and another person receiving the money using their respective personal communication devices, for instance, when both the individual and the other person do not have a registered account associated with a financial entity. The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

The following presents a simplified summary of various aspects of the disclosed subject matter in order to provide a basic understanding of such aspects. This summary is not an extensive overview of all contemplated aspects, and is intended to neither identify key or critical elements nor delineate the scope of such aspects. Its sole purpose is to present some concepts of the disclosed subject matter in a simplified form as a prelude to the more detailed description that is presented later.

Techniques for efficient transfer of funds between parties using personal communication devices are presented. A money transfer service (MTS) can be associated with a transfer management component (TMC) that can control money transfers between a sender via the sender's communication device (e.g., personal phone or computer) and an intended recipient via the intended recipient's communication device, even if the intended recipient is not registered with the TMC. A sender can use the sender's communication device to generate a transfer fund request, wherein the transfer fund request can be in the form of an MTS message or other type of message (e.g., text message, instant message (IM), email message, multimedia message, etc.). The transfer fund request can include the name of the intended recipient, the address associated with the intended recipient (e.g., communication address, such as a phone number, email address, or other messaging address (e.g., associated with a social network)), the amount of funds to be transferred, the account (e.g., MTS service account or other account of the sender) from which the funds are to be withdrawn, a secure token, a personal message from the sender to the intended recipient, and/or other information.

In accordance with various aspects, the sender can use the sender's communication device to transmit the fund transfer request message to the TMC and/or the communication device of the intended recipient. In an aspect, the TMC can analyze the content of the message to identify the name and/or MTS account of the sender, the name of the intended recipient, the address associated with the intended recipient, the amount of funds to be transferred, the account of the sender from which the funds are to be withdrawn, whether there is a personal message from the sender to the intended recipient in the request message, and/or other information. The TMC can generate a fund transfer message (e.g., fund transfer notification message) comprising the communication address of the intended recipient to which the fund transfer message is to be sent, a message specifying the amount of funds being transferred to the intended recipient and how the funds can be obtained by the intended recipient, a link (e.g., hyperlink) to an online page associated with the fund transfer wherein the link and online page can facilitate authenticating or validating the intended recipient with regard to the fund transfer, and/or other information. In another aspect, the TMC can withdraw the funds to be transferred from the specified account (e.g., if the funds are available; and/or another account if the funds are not available in the specified account, in accordance with the sender's user preferences) and move those funds to a temporary account, which can be associated with the link and online page, or can place a hold on or make an allocation of (e.g., partition of) such funds in the account wherein the hold or allocation can be associated with (e.g., linked with) the link or online page. In still another aspect, the TMC can transmit the fund transfer message to the communication address of the intended recipient, wherein the intended recipient can utilize the intended recipient's communication device to receive and access the fund transfer message.

The communication device of the intended recipient can receive or access the fund transfer message from the TMC (and/or the fund transfer request message from the sender's communication device, in accordance with various embodiments). For instance, the fund transfer message can be in the form of a text message, IM, or multimedia message sent to the phone number (e.g., mobile phone) associated with the intended recipient or an email message sent to the email address associated with the intended recipient. The intended recipient can access the fund transfer message, via a suitable message and/or web application, to view the message content, including the link and/or secure token therein. When the fund transfer message includes a link, which can be associated with an online page of the TMC, the intended recipient, using the user interface (UI) of the communication device, can select or manipulate the link, which can result in the communication device accessing the online page (e.g., via a web browser), wherein the online page can be associated with the fund transfer, and wherein the online page can facilitate authenticating or validating the intended recipient and/or intended recipient's communication device and transferring of the funds to the intended recipient when authenticated or validated, even if the intended recipient is not registered with the TMC and without requiring the intended recipient to be registered with the TMC, and without requiring that the intended recipient travel to a physical office associated with the TMC to obtain the funds or present a physical personal identification (e.g., driver's license or other photograph identification) of the intended recipient in person to a representative of the MTS.

In accordance with various aspects, the TMC, via the online page, can request that the intended recipient, using the intended recipient's communication device, provide authentication or validation information to the TMC to confirm or validate who the intended recipient is and that the intended recipient is the entity that is authorized to receive the transferred funds. For example, the TMC, via the online page, can request the intended recipient to insert the phone number or email address associated with the intended recipient in an address field on the online page and/or can request that the intended recipient select a get-code control on the online page. The address (e.g., phone number or email address) in the address field and/or a request for a code can be transmitted to the TMC. The TMC can compare the received address to the address associated with the fund transfer request to determine whether they match, wherein a match indicates that at least a first level of authentication or validation is satisfied. In another aspect, the TMC can transmit a unique code (e.g., unique code comprising alphanumeric or other characters) to the intended recipient at the address associated with the intended recipient and/or associated communication device (e.g., the phone number or email address of the intended recipient). The TMC can request that the intended recipient use the intended recipient's communication device to enter the unique code in a code field on the online page and press, select or manipulate an enter control on the online page to transmit the unique code for verification. The TMC can receive the unique code from the intended recipient's communication device and can compare the received unique code to the unique code the TMC had sent to the intended recipient's communication device to determine whether they match, and, if they match, the TMC can determine that a second level of authentication or validation is satisfied.

In response to the intended recipient satisfying the two levels of authentication or validation, the TMC can determine that the intended recipient and/or associated communication device is authenticated or validated, and can allow the intended recipient access to the transferred funds. For example, the TMC can allow the intended recipient to specify an account (e.g., bank or debit account) associated with the intended recipient into which the transferred funds can be deposited or can allow the intended recipient to use the funds to pay bills online (e.g., pay utility bill, credit card bill, etc.). In accordance with various other aspects and embodiments, alternatively or additionally, other types or levels of authentication or validation can be employed by the TMC to facilitate authenticating or validating the intended recipient in relation to a fund transfer, as more fully disclosed herein.

In accordance with another aspect, the disclosed subject matter can include a system that can comprise a communication device associated with an MTS and configured to transmit a fund transfer message to a destination associated with a payee to notify the payee of a fund transfer from a payer. The system can also include a TMC associated with the communication device and configured to receive a fund transfer request from a payer communication device associated with the payer, generate the fund transfer message to facilitate transfer of a specified amount of funds from an account associated with the payer to the payee, and at least one of verify the payee or associate an electronic object with the fund transfer message that requires the payee to be verified before access to the funds is granted to the payee, without the payee having to be registered with the MTS.

In accordance with an aspect, the disclosed subject matter can include a method comprising: employing at least one processor to facilitate execution of code instructions retained in a memory, the code instructions, in response to execution, perform acts comprising: transmitting a fund transfer message to a communication address associated with an intended recipient of funds associated with the fund transfer message, notwithstanding the intended recipient not being registered with a transfer management component that is managing a fund transfer associated with the fund transfer message; and controlling access to the funds by the intended recipient associated with the fund transfer message based at least in part on verification information associated with the fund transfer.

In accordance with a further aspect, the disclosed subject matter can comprise a computer program product comprising a computer readable storage medium having computer executable instructions stored thereon that, in response to execution, cause a computing system to perform operations, comprising: transmitting a fund transfer message to a communication address associated with a payee in relation to funds associated with the fund transfer message irrespective of whether the payee is registered with a TMC managing a fund transfer associated with the fund transfer message; and controlling access to the funds by the payee associated with the fund transfer message based at least in part on verification information associated with the fund transfer.

In still another aspect, the disclosed subject matter can include a communication device. The communication device can comprise a user interface configured to display information relating to a transfer of funds facilitated by an MTS. The communication device also can comprise a message component configured to receive verification information from a user of the communication device and provide the verification information to facilitate verification of the user to facilitate access to the funds by the user upon being verified, even if the user is not registered with the MTS.

The following description and the annexed drawings set forth in detail certain illustrative aspects of the disclosed subject matter. These aspects are indicative, however, of but a few of the various ways in which the principles of the disclosed subject matter may be employed. The disclosed subject matter is intended to include all such aspects and their equivalents. Other advantages and distinctive features of the disclosed subject matter will become apparent from the following detailed description of the disclosed subject matter when considered in conjunction with the drawings.

### BRIEF DESCRIPTION OF THE DRAWINGS

FIG. 1 illustrates a block diagram of an example system that can manage transfer of property (e.g., monetary funds) between users using communication devices associated with the users in accordance with various aspects and embodiments described herein.

FIG. 2 depicts a block diagram of an example communication device in accordance with various aspects and embodiments of the disclosed subject matter.

FIG. 3 illustrates a block diagram of an example transfer management component (TMC) in accordance with various aspects and embodiments of the disclosed subject matter.

FIG. 4 illustrates a block diagram of example system that can facilitate money transfers in accordance with various aspects and embodiments of the disclosed subject matter.

FIG. 5 depicts a diagram of an example fund transfer message generation flow that can facilitate generating and sending a fund transfer request using a web or mobile Money Transfer Service (MTS) application interface in accordance with various aspects of the disclosed subject matter.

FIG. 6 illustrates a block diagram of an example fund transfer message receipt flow that can facilitate receiving and obtaining funds associated with a fund transfer message using a web or mobile MTS application interface in accordance with various aspects of the disclosed subject matter.

FIG. 7 illustrates a block diagram of an example fund transfer message receipt flow that can facilitate receiving and obtaining funds associated with a fund transfer message using a message application interface in accordance with various aspects of the disclosed subject matter.

FIG. 8 presents a block diagram of an example fund transfer message receipt flow that can facilitate receiving and obtaining funds associated with a fund transfer message comprising a secure token using a message application interface in accordance with various aspects of the disclosed subject matter.

FIG. 9 depicts a block diagram of an example message flow relating to a fund request in accordance with various aspects.

FIG. 10 illustrates a flow diagram of an example method for verifying an intended recipient of funds in relation to an electronic fund transfer in accordance with various aspects and embodiments.

FIG. 11 depicts a flow diagram of an example method for managing fund transfers in accordance with various aspects and embodiments.

FIG. 12 presents a flow diagram of an example method for sending funds via a message interface associated with a service account associated with a user in accordance with various aspects and embodiments.

FIG. 13 is a flow diagram of an example method for receiving transferred funds via a message interface on a communication device associated with an unregistered intended recipient in accordance with various aspects and embodiments.

FIG. 14 is a flow diagram of an example method for verifying an intended recipient of a fund transfer who is not registered with the TMC in accordance with various aspects and embodiments.

FIG. 15 presents a flow diagram of an example method for generating a secure token comprising transferred funds in accordance with various aspects and embodiments.

FIG. 16 depicts a flow diagram of an example method for gaining access to funds associated with a secure token in accordance with various aspects and embodiments.

FIG. 17 is a flow diagram of an example method for requesting funds from another entity in accordance with various aspects and embodiments.

FIG. 18 is a flow diagram of an example method for managing and processing a fund request in accordance with various aspects and embodiments.

FIG. 19 illustrates a flow diagram of an example method for transferring funds in response to a fund request in accordance with various aspects and embodiments.

FIG. 20 is a diagram of an example wireless communication device in accordance with various aspects and embodiments of the disclosed subject matter.

FIG. 21 is a schematic block diagram illustrating a suitable operating environment.

FIG. 22 is a schematic block diagram of a sample-computing environment.

### DETAILED DESCRIPTION

Various aspects of the disclosed subject matter are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects.

Techniques for efficient transfer of funds between parties using personal communication devices are presented. A sender can use a first communication device to transfer funds from an account associated with the sender to an intended recipient via a communication address (e.g., phone number, email address, address associated with a social network, etc.) associated with the intended recipient's second communication device even if the intended recipient is not registered with a financial service provider (e.g., money transfer service (MTS)) associated with the account (e.g., MTS service account) of the sender, without requiring the intended recipient to travel to a physical office or present a physical personal identification (e.g., driver's license or other photo identification) to obtain the funds. The fund transfer can be managed by a transfer management component (TMC) associated with the MTS. In an aspect, the sender can use the first communication device to generate a fund transfer request and can transmit the fund transfer request to the TMC, wherein the transfer fund request can include the intended recipient's communication address, the amount of funds, the account from which the funds are to be withdrawn, and/or other information. The TMC can generate a fund transfer message, comprising the communication address of the intended recipient, a link that facilitates retrieving the funds, information regarding how to obtain the transferred funds, and/or other information (e.g., personal message from the sender). The TMC can transmit the fund transfer message to the intended recipient's communication address. The intended recipient can use the second communication device (e.g., the intended recipient's communication device) to view the fund transfer message (e.g., fund transfer notification message), and can select the link, which can redirect the communication device to an online page relating to the fund transfer and associated with the TMC. Via the online page, the TMC can request authentication or validation information from the intended recipient to facilitate authenticating or validating the intended recipient before allowing the intended recipient access to the transferred funds. The TMC can authenticate or validate the intended recipient based at least in part on the communication address and/or a validation code. When validated, the TMC can allow the intended recipient access to the transferred funds, wherein the intended recipient can request that the TMC deposit the transferred funds in an account (e.g., a bank or debit account with a third party) associated with the intended recipient or transfer all or a portion of the funds to another destination (e.g., allow the intended recipient to specify an account associated with a utility or a credit card to which funds are to be transferred, for instance, to pay a bill of the intended recipient).

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

In another example, respective components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “mobile station,” “mobile,” “wireless device,” “wireless communication device,” “access terminal,” “terminal,” and similar terminology are used herein to refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the term “access point” (AP), can be or can comprise a base station, Node B, Evolved Node B (eNode B or eNB), Home Node B (HNB), home access point (HAP), and can refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” and the like are employed interchangeably throughout the subject specification, unless context warrants particular distinction(s) among the terms. It should be appreciated that such terms can refer to human entities or automated components supported through artificial intelligence (e.g., a capacity to make inference based on complex mathematical formalisms), which can provide simulated vision, sound recognition and so forth.

As used herein, the terms “example,” “exemplary,” and/or “demonstrative” are utilized to mean serving as an example, instance, or illustration. For the avoidance of doubt, the subject matter disclosed herein is not limited by such examples. In addition, any aspect or design described herein as an “example,” “exemplary,” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

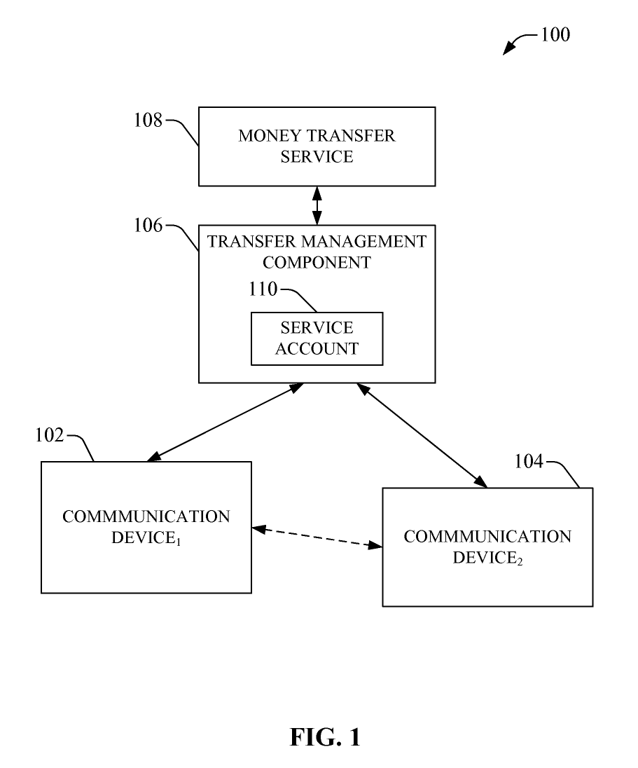

Referring now to the drawings, FIG. 1 illustrates a block diagram of an example system 100 that can manage transfer of property (e.g., monetary funds) between users using their respective communication devices in accordance with various aspects and embodiments described herein. While the disclosed subject matter will often be described herein with regard to the transfer of monetary funds, the disclosed subject matter is not so limited, as other property (e.g., credit line, electronic items of property, etc.) also can be transferred in accordance with the aspects and embodiments disclosed herein.

In an aspect, the system 100 can include a first communication device 102 (also referred to as communication device₁), which can be associated with a first user, and a second communication device 104 (also referred to as communication device₂), which can be associated with a second user. The first communication device 102 and second communication device 104 each can be a wired or wireless communication device, such as, for example, a mobile or wireless communication device (e.g., a mobile phone and/or smart phone), a personal digital assistant (PDA), a computer (e.g., laptop computer), a set-top box, an electronic notebook, an electronic pad or tablet (e.g., iPad), a portable electronic gaming device, a landline phone with messaging capabilities (e.g., voice mail, mobile messaging capabilities (e.g., text message, instant message, multimedia message, etc.)), etc. For example, the first communication device 102 can be a device used by a first user (e.g., payer or sender), who desires to use the first communication device 102 to send monetary funds to the second user (e.g., payee, intended recipient, receiver), wherein the second user can obtain or manage the monetary funds using the second communication device 104.

In accordance with various aspects and embodiments, the system 100 can comprise a transfer management component (TMC) 106 that can be communicatively connected, at least at certain times, to the first communication device 102 and/or second communication device 104 to facilitate efficiently transferring funds between accounts (e.g., mobile service financial account, such as a Money Transfer Service (MTS) account, and/or an account (e.g., bank account, credit account, utility account, etc.) associated with a financial or business institution, such as a bank, credit union, store, utility, business, etc.) and associated with the first user (and associated first communication device 102) or second user (and associated second communication device 104). The TMC 106 can comprise or be associated with an MTS 108, which is a service usable to transfer funds between communication devices. In an aspect, the TMC 106 can control the transfer of funds from the first user associated with the first communication device 102 to the second user associated with second communication device 104 even if the second user (and/or associated second communication device 104) is not registered with the TMC 106 and associated MTS 108.

In accordance with various other aspects, the TMC 106 can enable a user to manually or automatically transfer funds between the MTS service account and other third-party financial accounts of the user (e.g., associated with third-party institutions), and/or enable the user to transfers to other accounts, such as accounts associated with utility services, credit cards, or other types of service or product providers. In accordance with still other aspects, the TMC 106 can efficiently manage financial transactions (e.g., transfer of funds) between a registered MTS user and businesses (e.g., taxi drivers, brick-and-mortar businesses, online businesses, etc.) via, for example, pull payments facilitated using the first communication device 102, wherein the TMC 106 can manage and process the pull payments.

In accordance with various aspects and embodiments, the first communication device 102 can transfer funds using a web or mobile application (e.g., web application associated with the MTS 108 and provided by the TMC 106; or a mobile application associated with the MTS 108, provided by (e.g., downloaded to the first communication device 102 from) the TMC 106 (or a third-party vendor, such as a mobile phone service provider), and/or installed on the first communication device 102), a message application, such as, for example, a text message application (e.g., for sending and receiving text messages via a short message service (SMS)), instant message (IM) application, multimedia message application (e.g., for sending and receiving multimedia messages via a multimedia messaging service (MMS)), email message application, or voice mail message application, wherein a message application can be used to send or receive messages, including messages from the first communication device 102 to the second communication device 104 via a communication network and as controlled by the TMC 106, to facilitate transferring funds from the first user to the second user. The respective applications (e.g., web application, mobile application, message application) each can have respective application interfaces that can be presented and used on the first communication device 102. Similarly, the second communication device 104 can employ one or more of the respective applications, although the second communication device 104 is not required to have or access, for example, a web or mobile application associated with the TMC 106 and associated MTS 108 in order to receive funds being transferred from, for example, the first user, via the TMC 106 and associated MTS 108.

In an aspect, to facilitate fund transfers via the MTS 108, the first user can use the first communication device 102 (or another communication device) to register the first user and/or first communication device 102 with the MTS 108 via the TMC 106, wherein the registration can be a regular registration for an unspecified amount of time or can be a one-time or temporary registration to facilitate a one-time fund transfer to the second user via, for example, the second communication device 104. As part of the registration process, the first user can provide information (e.g., name, address, financial account information, etc.) to the TMC 106 to facilitate registering at least one account (e.g., bank account, credit card account) of the first user with the MTS 108. The first user (e.g., via the first communication device 102) and/or the TMC 106 can provide (e.g., generate and present) authentication credentials (e.g., username, password, personal identification number (PIN), biometric information (e.g., fingerprint information, eye or iris related information, facial recognition related information, etc.) associated with the first user, communication device identifier (e.g., Media Access Control (MAC) address), etc.)

Similarly, optionally, if desired, the second user (e.g., using the second communication device 104) can register with the MTS 108 via the TMC 106 to facilitate fund transfers via the MTS 108, although the second user is not required to register with the TMC 106 and associated MTS 108 in order to receive funds transferred from another user (e.g., first user) via the TMC 106 and associated MTS 108. For instance, when the second user is not registered with the TMC 106, and the first user sends a fund transfer request to the TMC 106 to transfer funds to the second user at a communication address associated with the second user, the TMC 106 can generate a fund transfer message and transmit it to the communication address associated with the second user, wherein the TMC 106 can control the transfer of funds to the second user by validating or authenticating the second user and/or associated second communication device 104, based at least in part on the communication address associated with the second user, a communication device identifier, a code (e.g., validation code) and/or using another specified type of validation or authentication process (e.g., submitting a digital image of the second user, the first user, or another known digital image, via the second communication device 104 to validate or authenticate with the TMC 106), before the TMC 106 allows the second user to access or use the transferred funds, as more fully disclosed herein.

As an example of doing a fund transfer to an intended recipient who is not registered with the TMC 106, the first user can use the first communication device 102 to access an application, such as web or mobile application (e.g., web or mobile MTS application) or a message application (e.g., text message application, IM application, email application, etc.), and, in response, an application interface can be presented on a UI (e.g., graphical UI (GUI) or touch screen GUI) of the first communication device 102 to the first user. The UI can include one or more UI controls or buttons, such as a control to send funds to another user (e.g., contact on a contact list), wherein such control can be labeled as desired (e.g., a “send money” control or “transfer money to contact” control). The UI controls also can comprise a “call” control to initiate a phone call to the specified user or a “message” control to send a message (e.g., IM, text message, email message, etc.) to the specified user. All or a portion of the UI controls can be presented along with the contact list or upon selection of a contact from the contact list or entering information relating to an entity not currently on the contact list.

To send funds to the second user, the first user can use the application interface (e.g., web or mobile MTS application) on the first communication device 102 to select the second user (e.g., intended recipient of the transferred funds) from the contact list or enter information, such as address information (e.g., phone number, email address, etc.), for the second user via the application interface. The application interface can present a field (e.g., a pop-up field) to the first user to enter a fund amount to transfer or a predefined set of typical fund amounts (e.g., $20, $50, $100, . . . ) wherein the first user can interact (e.g., touch, gesture, select a button) with the application interface to select the desired fund amount from the set, and/or can present a menu (e.g., tool bar, pop-up menu, etc.) with available options, controls, buttons, etc., which can include a set of registered accounts (e.g., service account 110, bank account, credit line account) from which the funds to be transferred can be withdrawn and the first user can select a desired account from which to withdraw the funds for the transfer.

The first user also has the option of using the application interface to generate and send a message (e.g., a personal message, such as “Hi [second user], here is the money I promised you.”) with the MTS fund transfer. Once the first user has completed the fund transfer request, the first user can use the application interface to submit (e.g., transmit) the fund transfer request to the TMC 106 for processing.

The TMC 106 can receive the fund transfer request (e.g., MTS fund transfer request) from the first communication device 102. If the first communication device 102 is not yet authenticated by the TMC 106, the TMC 106 can request that authentication credentials be provided by the first communication device 102, and the TMC 106 can authenticate the first communication device 102 (and associated first user), as more fully disclosed herein. The TMC 106 can analyze the information in the fund transfer request and the user profile of the sender, to identify the sender (e.g., first user), the second user (e.g., intended recipient), the destination address (e.g., phone number, email, etc.) associated with the second user, the amount of the fund transfer, the account (e.g., service account 110) from which the funds are to be withdrawn, user preferences of the first user, message content in the request, etc., and further can identify that the second user is not registered with the TMC 106. Based at least in part on the results of the analysis, the TMC 106 can process the fund transfer request and can withdraw the funds from an account (e.g., service account 110) of the first user (e.g., as specified in the request or in accordance with the first user's user preferences), or can place a hold on or allocate (e.g., partition) the funds being transferred while those funds remain in the first user's account, wherein the held or allocated funds can be associated with the second user or fund transfer request. In an instance where the funds are withdrawn from the first user's account prior to disbursing the funds to the second user, the TMC 106 can create a temporary service account and can place the transferred funds in the temporary service account and associate that temporary service account with the unregistered second user or fund transfer request. The TMC 106 also can update the account information (e.g., update the account balance, generate and update transaction records associated with the first user, etc.) associated with the first user based at least in part on the fund transfer.

In another aspect, the TMC 106 also can generate a fund transfer message (e.g., fund transfer notification), comprising the name of the second user (e.g., intended recipient), the communication address of the second user to which the fund transfer message is to be sent, the amount of funds being transferred to the second user, a link that can be selected by the second user to facilitate obtaining the funds, the name of the first user (e.g., sender of funds), a message notifying the second user of how to obtain the transferred funds, a personal message from the first user, a secure token, and/or other information. The TMC 106 can transmit the fund transfer message to the communication address of the second user.

The fund transfer message can be received at the communication address associated with the unregistered second user, wherein the second communication device 104, via a UI, can present a notification of the fund transfer message to the second user. The second user can utilize the second communication device 104 access the fund transfer message.

In accordance with various aspects, when the second user is not registered with the TMC 106, and receives a fund transfer message from the TMC 106 (or first communication device 102), the second user (and associated second communication device 104) is not necessarily required to be authenticated by the TMC 106 in the same manner as the registered first user is to be authenticated in order to transfer the funds, although, as desired, authentication procedures can be employed to authenticate the second user (and associated second communication device 104). For example, when the second communication device 104 receives the fund transfer message, the second user can select the “accept money” link in the message, which can result in an online page associated with the TMC 106 opening up on an interface (e.g., web browser window) on the second communication device 104. The online page can request that the second user and/or associated second communication device 104 be authenticated or validated before transferring the funds to the second user. For instance, the online page can request that the second user enter the phone number of the second communication device 104 (or email address associated with the second user) in the phone number field (or email field) on the online page, and further request that the second user press a “get code” button or control on the online page, wherein selection of the “get code” button can or control can result in an authentication or a validation code being sent to the second communication device 104 by the TMC 106, wherein the authentication or validation code can be a unique code for that particular fund transfer. The online page can further request that the second user enter the received code into a code field on the online page, and press an “enter” control on the online page to submit the code to the TMC 106 for verification by the TMC 106.

If the code matches the code the TMC 106 sent to the second communication device, the TMC 106 can deem the second user and second communication device 104 authenticated, and can allow the unregistered second user to access and manage the transferred funds. If the code does not match the code the TMC 106 sent to the second communication device, the TMC 106 can deem the second user and second communication device 104 as not being authenticated, and can deny the second user access to the transferred funds, and/or can allow the second user to attempt to authenticate or validate again up to a predefined maximum threshold number of authentication or validation attempts, after which access to the funds can remain denied and the second user and/or second communication device 104 can be locked out from attempting to access the funds for a predefined amount of time or until a reset is performed in relation to the fund transfer. If the fund transfer fails (e.g., the second user is unable to authenticate or validate with the TMC 106), the TMC 106 can generate a transfer failure message and can transmit the transfer failure message to a communication address of the first communication device 102 to notify the first user of the failure of the funds transfer to the second user and/or the reason(s) for the failure.

As another example, the first user can include a challenge (e.g., question) as part of the fund transfer request (e.g., whether in an MTS request or a message (e.g., text, IM or email message) to the second user), which can require a valid response (e.g., valid answer to the question in the challenge) from the second user in order for the second user to be able to obtain the transferred funds via the TMC 106. In such instance, the TMC 106 can allow the second user to obtain the transferred funds if a valid response is provided to the TMC 106 in response to the challenge, or the TMC 106 can deny the transferred funds if the response from the second user (e.g., via the second communication device 104) is not valid, wherein the TMC 106 can allow the second user to provide a valid response up to a predefined number of attempts to provide a valid response. If a valid response is not received within the predefined number of attempts, the TMC 106 can deny the second communication device 104 (and associated second user) access to the transferred funds and/or can transmit a message to the first communication device 102 (and/or associated first user) and the second communication device 104 (and/or associated second user) notifying the first and/or second user of the failure to complete the fund transfer, in accordance with predefined transfer criteria. The first and/or second users can take further action to attempt to complete the fund transfer, as desired (e.g., first user can re-submit or re-authorize the fund transfer to the second user).

As another example, the fund transfer request or fund transfer message from the first user can comprise a digital image (e.g., digital picture) of or associated with the second user (or first user) or other information (e.g., authentication information, such as a validation code) that can be used to facilitate authenticating the second user with regard to a fund transfer, wherein the digital image can comprise physical features of the second user (or first user) or another digital image that can be known to the second user, and the second user can provide a same or representative digital image (e.g., image comprising the second user's face or corresponding other digital image) (or corresponding code) to that provided as part of the fund transfer request to the TMC 106, and the TMC 106 can compare the image provided as part of the fund transfer request (or other provided authentication information) to the image (or other authentication information) provided by the second communication device 104 of the second user, and the TMC 106 can authenticate the second user if the authentication information provided by the second user matches, or at least substantially matches, the authentication information associated with the fund transfer request or fund transfer message, or the TMC 106 can determine that the second user is not authenticated if the authentication information provided by the second user does not match, or does not at least substantially match, the authentication information associated with the fund transfer request or fund transfer message.

Once the second user has been validated or authenticated by the TMC 106, the TMC 106 can allow the second user to access the funds. In one aspect, to obtain the transferred funds, the second user can provide the TMC 106 with account information to have the funds transferred to an account (e.g., bank or debit account) of the second user with a third party financial institution. Certain unregistered users may not desire to provide their account information to the MTS 108 though. In another aspect, the TMC 106 can maintain and manage the funds in a temporary service account, which can be associated with and accessed by the second user without the second user having to register with the TMC 106 and associated MTS 108. In an embodiment, an access code can be associated with the temporary service account, wherein the access code can be presented to obtain funds from the temporary service account. The second user can use the second communication device 104 to access the temporary account, using the access code, when the second user is making purchases online or at a physical store location, for example. In an embodiment, the access code can be presented on the UI of the second communication device 104 in machine-readable code (e.g., bar code), which can be scanned or read by another electronic device (e.g., bar code scanner or reader), for example. Still another option available to the second user is that the TMC 106 can provide the second user information via the second communication device 104 that can instruct the second user how to obtain the transferred funds from a physical (e.g., geographical) address associated with the TMC 106, wherein the second user can travel to the physical address to obtain the funds.

In accordance with various aspects and embodiments, the TMC 106 can generate and transmit a token, such as a secure token, to the second communication device 104, wherein the token can comprise the transferred funds (e.g., in an electronic form, as an electronic structure, as an electronic object) or information relating to the transferred funds to facilitate obtaining and/or using of the transferred funds by the second user, as more fully disclosed herein. For example, the secure token can be an electronic form of money or a mobile temporary financial account comprising a specified amount of funds (e.g., the transferred funds). In an aspect, a secure token can be a one-time secure token that can only be used for a single withdrawal of purchase, or a limited-use secure token that can be used a multiple number of times until the funds associated with the secure token have been exhausted, until the secure token has been accessed a specified number of times, or until a predefined amount of time has expired.

In accordance with another aspect, the secure token can be secured by locking the secure token and/or encrypting information and/or the funds in the secure token, in accordance with predefined security protocols (e.g., cryptographic protocols or algorithms). For example, a secure token can be locked and/or encrypted wherein a code, key, or authentication information (e.g., authentication credentials), etc., can be utilized with a cryptographic protocol or algorithm to lock the secure token and/or encrypt the information and/or funds contained in the secure token. For instance, the code, key, or authentication information, and/or a random or pseudo-random number (e.g., from a random number generator employed by the TMC 106 or a mobile TMC of a communication device (e.g., 102, 104)) can be used to lock the secure token such that the secure token cannot be unlocked, nor the funds or information therein accessed, unless the code, key, or authentication information, and/or the random or pseudo-random number, is presented to the secure token (e.g., input to an interface associated with the secure token) via the communication device. Additionally or alternatively, the code, key, or authentication information, and/or a random or pseudo-random number can be used to encrypt data (e.g., information, funds) contained in the secure token such that the data contained in the secure token cannot be decrypted and the information and/or funds therein cannot be presented in decrypted form to a user via a communication device unless the code, key, or authentication information, and/or the random or pseudo-random number, is presented to the secure token (e.g., input to an interface associated with the secure token) via the communication device. As an example, if an intended recipient receives a secure token that is contained on the communication device (e.g., 104) of the intended recipient, and the intended recipient attempts to access the secure token, for instance, by selecting the secure token via a UI of the communication device, the secure token can present a UI (e.g., secure token UI) on the communication device and can request the intended recipient to input information, such as the code, key, authentication information, etc. (e.g., phone number, authorization or validation code or password known to the intended recipient, response (e.g., answer) to a challenge (e.g., question), etc., which can be in a same or similar manner as validation or authentication of an unregistered recipient of transferred funds with the TMC 106), wherein the input information, if valid, can unlock the secure token and/or decrypt the data therein, or, access to the secure token can be denied, or unusable or no information can be presented, if the input information is not valid.

In an aspect, the second user (e.g., intended recipient), using the communication device (e.g., 104), can present the secure token, as unlocked and/or decrypted, to another communication device associated with an entity (e.g., a store, a utility, a credit provider, a financial institution, a friend, etc.) to use or transfer the funds contained in the secure token. Alternatively, the second user, using the second communication device 104, can present the secure token, still secured, to another communication device associated with an entity to use or transfer the funds contained in the secure token, wherein the second communication device 104 or second user can provide the input information that can be used to unlock and/or decrypt the secure token.

In another aspect, to transfer all or a portion of the funds contained in a secure token, the second communication device 104 can transmit the secure token (or a portion of the funds in the secure token) to the other communication device of the entity via a direct (e.g., wireless) communication channel or via a communication network, as more fully described herein. As a result, the secure token can be immediately used as money without further involvement of the TMC 106.

Additionally or alternatively, a secure token can include information relating to the transferred funds, but not the funds themselves. The secure token can be unlocked and/or the information contained in the secure token can be decrypted, as described herein. To provide the information relating to the funds contained in the secure token, the second communication device 104 can transmit the secure token to the other communication device of the entity via a direct (e.g., wireless) communication channel or via a communication network, as more fully described herein, or the secure token can comprise or be associated with a bar code or other machine-readable code (e.g., computer readable code) that can be presented, via an interface on the second communication device 104, wherein the machine-readable code can be scanned or read by the other communication device of the entity, and wherein the information contained in the machine-readable code can provide the other communication device with information relating to the funds associated with the secure token. The other communication device of the entity can present the information relating to the secure token to the TMC 106, and/or other information (e.g., code, key, authentication information, etc., if necessary) to facilitate obtaining the funds associated with the secure token, and the TMC 106 can provide the funds to the other communication device or to an account associated with the entity.

In yet another aspect, the first communication device 102 can generate a secure token (e.g., via a mobile TMC, as more fully disclosed herein) with or without the initial involvement of the TMC 106. For instance, the first communication device 102 can use the web or mobile MTS application to generate a secure token comprising the transferred funds or information relating thereto. The first communication device 102 optionally can notify the TMC 106 about the secure token or provide a copy of the secure token to the TMC 106, but is not required to do so. The first communication device 102 can generate and transmit a message, comprising the secure token, to the second communication device 104 via a direct communication channel or via the communication network, as more fully described herein. If the funds are contained in the secure token, the intended recipient associated with the second communication device 104 can retrieve the funds from the secure token, as described herein, without having to contact the TMC 106, unless the secure token is structured to require such contact. Such use of a secure token and transmission via a traditional type of communication (e.g., email, IM, text message, etc.) received from a known sender can be useful, as the intended recipient can have a desired level of trust in relation to such a message from the sender, while the intended recipient may not have as high of a level of trust with a message (e.g., MTS message) received from a third-party communication device (e.g., TMC 106) or entity. In another aspect, as desired, the secure token can be structured such that the intended recipient, using the second communication device 104, can be required to present the secured token or information (e.g., code or other authentication or authorization information) relating thereto to the TMC 106 in order to use and/or obtain the transferred funds.

To facilitate processing of the secure token by the second communication device 104 (e.g., when the second communication device 104 is not registered with the TMC 106), the controlling of the locking and unlocking of the secure token, encryption and decryption of information of the secure token, and/or the presentation of an interface associated with the secure token, can be performed or facilitated by an application, which can be an application that can typically already be installed on the second communication device 104 or an application that is part of the secure token.

In accordance with various aspects, the second user can be registered with the TMC 106, and the second communication device 104 also can access or comprise a web or mobile MTS application and can present a web or mobile application interface to the second user. In such instance, when the second communication device 104 receives a fund transfer message, the received message or notification can be presented (e.g., displayed) to the second user via the application interface, and the second user can view the information (e.g., amount of funds transferred, account into which the funds were transferred, secure token that can be used to immediately utilize the transferred funds, information identifying the sender of the funds, personal message from the sender, etc.) contained in the message or notification. At a desired time (e.g., immediately or at a future time), the second user can use the second communication device 104 (or another associated communication device) to authenticate with the TMC 106 to access the second user's service account or other registered account to retrieve all or a portion of the transferred funds, utilize (e.g., spend) all or a portion of the transferred funds (e.g., using a secure token relating to the transferred funds), transfer the transferred funds to a different account of the second user, etc.

In accordance with still other aspects, an entity (e.g., creditor, store, utility company, person, etc.), which can be the first user using the first communication device 102 in system 100, can utilize the MTS 108 and associated TMC 106 to request users, including users (e.g., second user) who are not registered with the TMC 106, to make a payment or fund transfer to the entity via the TMC 106, which can manage the payment or fund transfer. For example, the entity can be registered with the TMC 106, and can use the first communication device 102 to log in to the TMC 106 and be authenticated by the TMC 106. The entity can use the first communication device 102, and/or the web or mobile MTS application, to generate the request for funds (e.g., request for fund transfer, request for bill payment). For example, the entity can complete a fund request form presented on the UI of the first communication device 102. The fund request can specify the third party (e.g., the second user) to which the fund request is directed, a communication address associated with the second user to which the fund request is to be forwarded, information identifying the fund requestor (e.g., the entity), the amount of funds requested, a due date(s) by which the funds should be received by the entity, etc., and can transmit the request for funds to the TMC 106.

The TMC 106 can receive the fund request from the first communication device 102 and can generate a fund request notification, comprising all or a portion of the information contained in the fund request, and/or other information, such as information instructing the second user how to go about paying or transferring the requested fund amount, a link to an online registration page associated with the TMC 106 to allow the second user to register with the TMC 106 if the second user desires, a link to the web or mobile MTS application to enable the second user to download the web or mobile MTS application to the second communication device 104 (e.g., if the second user is registering with the TMC 106, or if the second user wants to use the web or mobile MTS application to generate a secure token comprising funds to satisfy the fund request). The TMC 106 can transmit the fund request notification to the second communication device 104, which can receive the fund request notification.

In accordance with various aspects, the second user can register with the TMC 106 and associated MTS 108 or can remain an unregistered user, for instance, when responding to the fund request notification. If the second user decides to register with the TMC 106, the second user select the registration link in the fund request notification, wherein the second communication device 104 can be directed to an online registration page associated with the TMC 106 (e.g., opened in a web browser of the second communication device 104). The second user can register with the TMC 106 by following the registration process that the first user followed in registering with and logging into the TMC 106. The second user also can download the web or mobile MTS application onto the second communication device 104.

When the second user is registered, The TMC 106 can create a service account and associate it with the second user. As desired, the second user can enter account information relating to accounts (e.g., bank or debit account, credit account, etc.) from other financial institutions associated with the second user, and such account(s) can be associated with the service account of the second user. In an aspect, the second user can respond to the fund request notification and can use the second communication device 104 to generate a fund transfer request comprising information to schedule and authorize a payment now or a future payment to a communication address (e.g., phone number, email address) associated with the fund requestor, wherein the funds can be withdrawn from an account associated with and specified by the second user at a time specified in the fund transfer request. The fund transfer request can be submitted to the TMC 106 for processing.

The TMC 106 generate a scheduled transfer notification, which can comprise information, such as the amount of the funds being transferred, the intended recipient of the funds (e.g., fund requestor), the communication address to which the scheduled transfer notification is being sent, a link that can be used to obtain the funds when transferred, the date or time the fund transfer is to be executed, and/or other information. The TMC 106 can transmit the scheduled transfer notification to the communication address of the intended recipient (e.g., the communication address specified by or associated with the fund requestor in the fund request). At the scheduled time, the funds can be transferred from the account associated with the second user as specified in the fund transfer request to the account associated with the fund requestor as specified in the fund request or in accordance with the user preferences of the fund requestor.

In accordance with other aspects, if the second user does not want to register with the TMC 106, the second user can still respond to the fund request notification by scheduling a fund transfer to the fund requestor, if desired. In an aspect, the second user can use the second communication device 104 to download the web or mobile MTS application or other MTS application to the second communication device 104, for example, by selecting a link to an online page associated with the application in the fund request notification. The MTS application can be opened on the second communication device 104 and can be used by the second user to generate a secure token, without having to register with or involve the TMC 106 in the generation of the secure token. For example, the second communication device 104 can utilize the MTS application to generate a secure token comprising the amount of funds to be transferred or an authorization to withdraw the fund amount from the second user's account, the date or time the funds are to be transferred, the communication address of the fund requestor or other information identifying the fund requestor, and/or other information. The second user can use the second communication device 104 to access an account of the second user from which the funds are to be withdrawn and can transfer the funds from the account to the secure token or can generate or obtain a withdrawal authorization to withdraw the funds on the specified date or time. The second communication device 104, using the MTS application, can lock the secure token and/or encrypt the information contained in the secure token in accordance with a cryptographic algorithm(s), as more fully disclosed herein (e.g., as disclosed with regard to the first communication device 102).

In another aspect, the second communication device 104 can generate a message (e.g., MTS message, text message, IM, email message, multimedia message, etc.), such as a fund transfer request or notification, which can include the secure token (e.g., contained in, associated with, or attached to the fund transfer request), a communication address of the fund requestor, a personal message, and/or other information. The fund transfer request or notification, comprising the secure token, can be transmitted by the second communication device 104 to the TMC 106 or directly to the communication address of the fund requestor.

If the fund transfer request or notification is transmitted to the TMC 106, the TMC 106 can analyze it and can identify the communication address of the intended recipient (e.g., fund requestor), the date or time that the fund transfer is to occur, the secure token, and/or other information therein. The TMC 106 can generate a fund transfer notification that can comprise all or a portion of the information contained in the fund transfer request or notification from the second user. The TMC 106 can transmit the fund transfer notification to the communication address of the fund requestor immediately or at the date or time specified by the second user in the second user's fund transfer request or notification. The fund requestor can use the first communication device 102 to view the fund transfer notification, and can access the secure token at the date or time specified for the fund transfer by the second user, wherein the secure token can remain secured from being unlocked or decrypted until the date or time (e.g., immediately, future date or time) specified by the second user when the second communication device 104 was used to generate the secure token.

If the fund transfer request or notification is directly transmitted from the second communication device 104 to the communication address of the fund requestor, the fund requestor can receive notification of the fund transfer notification via the UI of the first communication device 102. The fund requestor can use the first communication device 102 to view the fund request notification. Regardless of whether the fund requestor is registered with the TMC 106 or not, the first communication device 102, using an MTS application, can access the secure token at the date or time specified by the second user to obtain the funds or the authorization to withdraw the funds from the account of the second user, as contained in the secure token. The fund requestor can use the first communication device 102 to unlock the secure token and/or decrypt the information in the secure token using the techniques (e.g., providing a code, providing a valid response to a challenge, providing a valid image, etc.) disclosed herein, which can involve the first communication device 102 and fund requestor interacting with the TMC 106 or second communication device 104 (e.g., to obtain the code, challenge, image, etc.) to facilitate unlocking the secure token or decrypting the information therein.

In accordance with still other aspects, in response to the fund request notification, the second user can utilize the second communication device 104 to access an account of the second user and can schedule a fund transfer to the fund requestor via an online payment application associated with the account. This also can enable the second user to submit a payment to the fund requestor without the second user having to register with the TMC 106.

With regard to registration with the TMC 106 and managing access to accounts of a registered user, in accordance with an aspect, when the first user attempts to access the first user's service account 110 or the first user's user profile associated with the service account 110, the TMC 106 can control access to the first user's service account 110 and user profile. For instance, the TMC 106 can require the first user to provide authentication credentials via the first communication device 102 to the TMC 106 when the first user desires to access the service account 110 or user profile. The TMC 106 can analyze (e.g., compare) the authentication credentials received from the first communication device 102 to authentication credentials stored in or by the TMC 106. If the received authentication credentials match the stored authentication credentials, the TMC 106 can grant the first user (and associated first communication device 102) a subset of access rights, including the right to access and/or modify the service account 110 and associated user profile. If the received authentication credentials do not match the stored authentication credentials, the TMC 106 can deny the first user (and associated first communication device 102) access to the service account 110 and associated user profile and/or can prompt the first user to enter valid authentication credentials, for example, up to a predefined maximum number of failed authentication attempts, wherein, if the predefined maximum number of failed authentication attempts have occurred (e.g., consecutively), the first user and/or first communication device 102 can be locked out of the service account 110 and user profile until predefined conditions (e.g., a predefined amount of lock-out time passes, a reset has been performed, etc.) are met.

In another aspect, when the first user and/or associated first communication device 102 is registered with the TMC 106, a service account 110 (e.g., mobile service account, such as an MTS account) can be created, associated with the first user and/or associated first communication device 102, and stored by the TMC 106, wherein the service account 110 can be used by the first user to facilitate transferring funds to desired entities, such as, for example, the second user, a creditor, a financial institution, a utility company, and/or a store or other business, etc., any of which can, but is not required to be registered with the MTS 108 via the TMC 106.

As desired, the first user also can add one or more accounts (e.g., bank account, credit line account, etc.) to the first user's registration, and/or can select or provide a set of user preferences (e.g., select an account to be a default account from which to withdraw funds or to which to deposit funds; select a predefined minimum threshold fund level for the service account 110, wherein when the service account is below that level, money can be automatically deposited from another account of the first user; select a predefined maximum threshold fund level for the service account 110, wherein when the service account is above that level, money can be automatically deposited from the service account 110 into another account of the first user; UI display preferences; etc.), wherein information associated with the first user can be stored by the transfer management component 106 in a user profile of the first user.

In accordance with various other aspects and embodiments, the first communication device 102 and second communication device 104 can employ near field communication (NFC) and/or other wireless communication technology(ies) (e.g., Bluetooth) to enable the first communication device 102 and second communication device 104 to communicate directly with each other, or employ other communication technology (e.g., mobile core network, Wi-Fi network, IP-based network, etc.) to communicate with each other, to facilitate a fund transfer between the first communication device 102 and second communication device 104, wherein the fund transfer can be processed via the TMC 106. In such instance, the first communication device 102 and second communication device 104 can be mutually authenticated with each other and/or the respective first and second users can use their respective communication devices 102 and 104 to agree to allow the respective communication devices 102 and 104 to communicate with each other.

In an aspect, once the first communication device 102 and second communication device 104 are mutually authenticated or are otherwise permitted to communicate with each other with regard to a fund transfer, the first communication device 102 and second communication device 104 can communicate with each other to exchange information relating to the fund transfer. For example, the first communication device 102 can obtain information (e.g., phone number, email address, account information, etc.) regarding the second communication device 104 (or second user) in order to generate a request for a fund transfer to the second user and/or the second communication device 104 can obtain information (e.g., identification information, account information, secure token, etc.) to facilitate the fund transfer from the first communication device 102.

For example, the first communication device 102 (e.g., using a web or mobile MTS application and/or associated application interface) can be employed to generate a secure token associated with (e.g., comprising or representing a specified amount of funds being transferred from the first user to the second user) and transmit the secure token directly from the first communication device 102 to the second communication device 104 via a direct communication connection (or via a communication network, such as a mobile core network, a Wi-Fi network, an IP-based network, etc.) between the first communication device 102 to the second communication device 104, wherein the second user can use the second communication device 104 to communicate with the TMC 106 to redeem or exchange the secure token to obtain the transferred funds associated with the secure token (e.g., single-use secure token or limited-use secure token) or otherwise use the transferred funds, and/or can transfer all or a portion of the transferred funds to a third user and/or associated third communication device (not shown in FIG. 1). In this example, the TMC 106 is not required to create a temporary service account for the second user (although the TMC 106 can create such a temporary service account for the second user) as the TMC 106 can process the secure token to withdraw the funds associated with the token from the service account 110 or other associated account of the first user and can provide the transferred funds to the second user, as specified by the second user (e.g., via information provided using the second communication device 104).

In an embodiment, direct communication or indirect communication (e.g., via the communication network without communicating the fund transfer via the TMC 106, or via the communication network by communicating the fund transfer via the TMC 106) of a fund transfer from the first user via the first communication device 102 to the second user via the second communication device 104 can be facilitated using a “bump” or “touch” feature that can be part of the web or mobile application or can be a separate application, wherein the communication relating to the fund transfer can be performed or facilitated by the first communication device 102 and second communication device 104 coming into contact with each other or within close proximity of each other (e.g., within a predefined distance of each other).

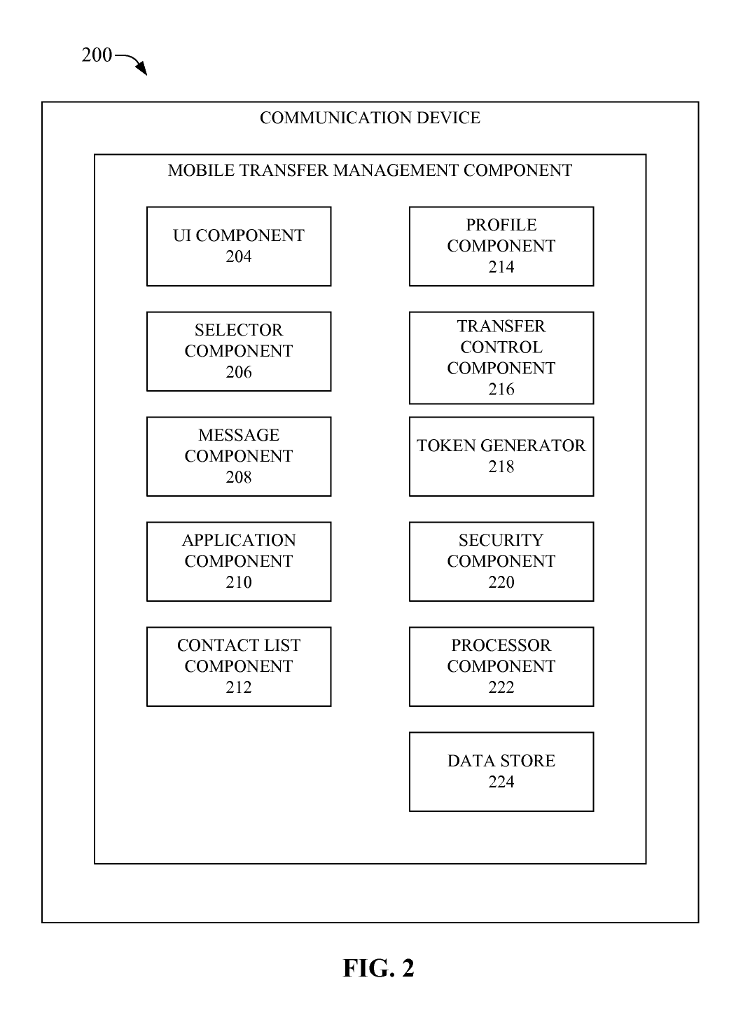

FIG. 2 depicts a block diagram of an example communication device 200 in accordance with various aspects and embodiments of the disclosed subject matter. In an aspect, the communication device 200 can comprise a mobile TMC 202 that can be employed to facilitate fund transfers between the communication device 200 and other communication devices in a communication network environment. In accordance with various aspects and embodiments, the communication device 200 can comprise all or a portion of the components described herein with regard to communication device 200 and as shown in FIG. 2, depending in part on whether the communication device 200 and associated user are registered with the TMC (e.g., 106) and associated MTS (e.g., 108) or not and/or whether an MTS application (e.g., web or mobile MTS application) is downloaded to or accessed by the communication device 200, wherein an MTS application can be a full version (e.g., for registered or unregistered users) or a “light” version (e.g., for unregistered users) comprising less components or features than the full version. In an aspect, when the user and device 200 are not registered with the TMC and associated MTS, and the device 200 does not have the MTS application, the communication device 200 may not contain a mobile TMC, but still can comprise other components, such as, for example, a UI component, selector component, message component, application component, contact list component, security component, processor component, data store, or other components.

In an aspect, the TMC 202 can comprise a UI component 204 that can provide one or more GUIs (e.g., message interface, MTS mobile application interface, etc.), command line interfaces, and the like. For example, a GUI (e.g., touch screen GUI) can be rendered that provides a user with a region or means to load, import, read, etc., data, and can include a region to present the results of such. These regions can comprise known text and/or graphic regions comprising dialogue boxes, controls (e.g., static controls), drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. In still another aspect, the UI component 204 can receive and/or respond to a swipe gesture(s) (e.g., via a touch screen GUI), wherein a desired action (e.g., unlocking of the communication device or associated display or keys, scrolling through a menu, moving from one area of a displayed item, such as a screen, to another area of that item, adjusting the size of a displayed item, etc.). For instance, a displayed menu or screen can be sized such that it is larger than the display screen of the UI component 204. The UI component 204 can receive a particular swipe gesture via the touch screen GUI, and in response, the menu can be scrolled to display different menu items, including items that were previously outside of the display area, or a different portion of the screen can be displayed, such as a region of the screen that was previously not viewable on the display prior to the swipe gesture. Alternatively or additionally, a mouse can be used to click and drag on the screen to move the screen in the display so that the desired portion of the screen is displayed on the display; or one or more buttons (e.g., ctrl button+an arrowed or directional button) on a keyboard can be manipulated to move the screen in the display so that the desired portion of the screen is displayed on the display. In an aspect, the user can interact with one or more of the components coupled to and/or incorporated into a processor(s) (e.g., host processor).

The user can also interact with the regions to select and provide information via various devices such as a mouse, a roller ball, a keypad, a track pad, a keyboard, a pen and/or voice activation, for example. Typically, a mechanism such as a push button or the enter key on the keyboard can be employed subsequent entering the information in order to initiate the search. However, it is to be appreciated that the disclosed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

Further, the UI component 204 can include or can be associated with a scanner that can receive data (e.g., authentication credentials, user data, etc.) from other components (e.g., host processor) associated with the mobile TMC 202. The scanner can be a type whereby a device (e.g., smart card) containing the data can be swiped through the scanner, which can read data associated with the device and/or the scanner can be a wireless scanner (e.g., RFID-type scanner) that can receive or read data associated with a device that contains the data when the device is within a predefined area near the wireless scanner such that the wireless scanner is able to communicate with the device to read or receive the data from the device.

In another aspect, the mobile TMC 202 can include a selector component 206 that can enable a user to select buttons, controls, links, files, folders, or other items, presented by or available via the UI component 204. In response to selection of an item, a corresponding action can be performed, wherein, depending in part on the item selected, the action can comprise, selecting a contact from a contact list, entering information (e.g., information regarding the fund amount) via the mobile TMC 202, selecting or opening a file or file folder, selecting a control (e.g., “transfer money” control), selecting a fund amount, selecting a link (e.g., “accept money” link), selecting a menu, selecting a message control to open a message application, etc.

In still another aspect, the mobile TMC 202 can contain a message component 208 that can be employed to generate, receive, or display MTS messages or requests, or other messages, such as text messages, IMs, multimedia messages, email messages, voice mail messages, notifications, etc. The message component 208, in conjunction with the UI component 204, can provide respective message interfaces in relation to the respective types of messages.

In yet another aspect, the mobile TMC 202 can include an application component 210 that can comprise one or more applications, including, for example, an MTS mobile application, a web browser application, a message application, a call application, a contact list application, a financial account application, and/or other desired applications, which can be pre-installed or downloaded onto the communication device associated with the mobile TMC 202 at a desired time. Respective applications can provide respective application interfaces that can be provided to the user via the UI component 204.

In an aspect, the mobile TMC 202 can comprise a contact list component 212 that can present a contact list of persons or entities who can be selected by the user, for example, to make a phone call, send a message, transfer money, etc. The user can utilize the selector component 206 to select a desired user from the contact list. The UI component 204 can be used to facilitate modifying the contact to add, remove, or change information (e.g., name, phone number, geographical address, email address, etc.) relating to a person or entity.

In another aspect, the mobile TMC 202 can comprise a profile component 214 that that can be employed to generate and maintain a user profile of the user, wherein the user profile can include information relating to the user, user preferences of the user, for example, in relation to fund transfers, account information regarding one or more accounts of the user, etc. The user, using the UI component 204 and profile component 214, can create or modify the user profile, as desired.

In still another aspect, the mobile TMC 202 can contain a transfer control component 216 that can be employed to control generation of fund transfers that are to be sent to other communication devices and associated users and processing of fund transfers received from other communication devices, including the TMC (e.g., 106), manage the user profile and account information associated with the user of the communication device 200, and perform other management functions relating to fund transfers.

In yet another aspect, the mobile TMC 202 can include a token generator 218 that, when desired, can be employed to generate a token, such as a secure token, that can comprise or be associated with a specified amount of monetary funds, wherein the token can be included in a fund transfer request or message to send funds to another communication device associated with the intended recipient. For example, monetary funds can be embedded or represented in an electronic form (e.g., data) in the secure token, wherein the secure token can be presented and used like physical money (e.g., paper money). A secured token can be secured using authentication protocols and cryptographic protocols to ensure that the secure token, and/or the embedded funds (when funds are embedded in the secure token), is only able to be accessed by an authorized entity (e.g., intended recipient, TMC).

In accordance with various aspects, the mobile TMC 202 can contain a security component 220 that can provide security with regard to fund transfers and messages. The security component 220 can employ authentication protocols and cryptographic protocols (e.g., protocol relating to data encryption and decryption, public key cryptography, symmetric key, Public key infrastructure (PKI), Digital Signature Standard (DSS), Data Encryption Standard (DES), triple-DES, Advanced Encryption Standard (AES), cryptographic hash functions, etc.) to facilitate securing fund transfer requests or messages, communications between the communication device 200 and the TMC (e.g., 106) or another communication device, securing secure tokens and information or funds contained therein, etc. The security component 220 can use a desired cryptographic protocol to encrypt voice or data for transmission and decrypt voice or data when received. The security component 220 can employ a desired authentication protocol(s) to control access to the web or mobile MTS application, the user profile, a secure token, etc., to allow access to an authorized entity (e.g., intended recipient, TMC) and deny access to an unauthorized entity, as more fully described herein. For example, the security component 220 can be used to lock or unlock a secure token, or encrypt or decrypt data associated with a secure token.

In an aspect, the mobile TMC 202 can comprise a processor component 222 that can work in conjunction with the other components (e.g., UI component 204, selector component 206, message component 208, etc.) to facilitate performing the various functions of the mobile TMC 202. The processor component 222 can employ one or more processors, microprocessors, or controllers that can process data, such as information relating to generating, sending, receiving or processing fund transfers, information relating to tokens, information relating to cryptography or authentication, information relating to other operations of the mobile TMC 202, and/or other information, etc., to facilitate operation of the mobile TMC 202, as more fully disclosed herein, and control data flow between the mobile TMC 202 and other components (e.g., other components of the communication device 200, TMC (e.g., 106), other communication device (e.g., 104), etc.) associated with the mobile TMC 202.

The mobile TMC 202 also can include a data store 224 that can store data structures (e.g., user data, metadata), code structure(s) (e.g., modules, objects, hashes, classes, procedures) or instructions, information relating to generating, sending, receiving or processing fund transfers, information relating to tokens, information relating to cryptography or authentication, information relating to other operations of the mobile TMC 202, and/or other information, etc., to facilitate controlling operations associated with the mobile TMC 202. In an aspect, the processor component 222 can be functionally coupled (e.g., through a memory bus) to the data store 224 in order to store and retrieve information desired to operate and/or confer functionality, at least in part, to the UI component 204, selector component 206, message component 208, etc., and/or substantially any other operational aspects of the mobile TMC 202.

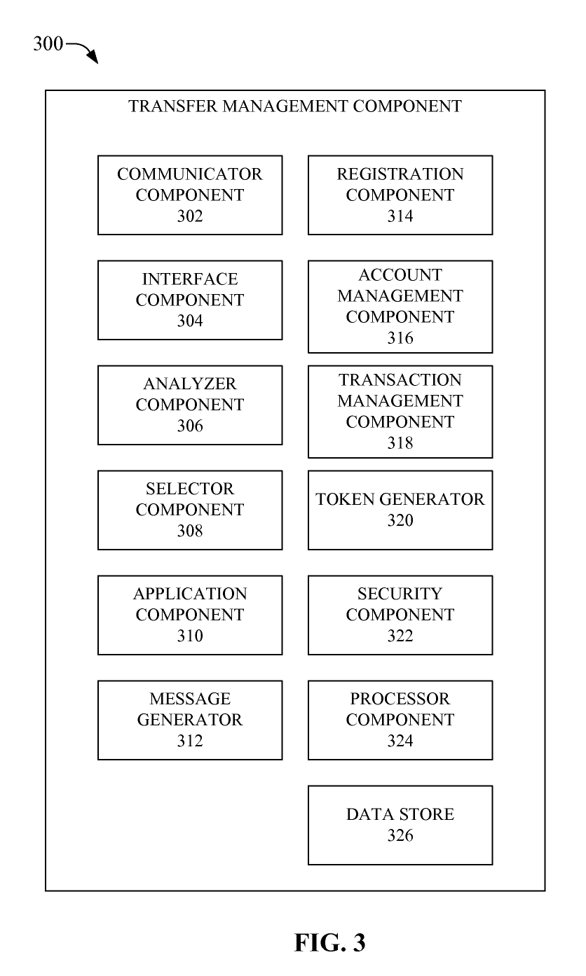

FIG. 3 depicts a block diagram of an example TMC 300 in accordance with various aspects and embodiments of the disclosed subject matter. In an aspect, the TMC 300 can comprise a communicator component 302 that can be employed to communicate (e.g., transmit, receive) information, including information relating to fund transfers, between the TMC 300 and other components or devices, such as communication devices associated with a communication network environment. The communicator component 302 can employ one or more communication protocols to facilitate controlling data or voice flows associated with the TMC 300.

In another aspect, the TMC 300 can include an interface component 304 that can comprise one or more interfaces, including one or more controls, switches, adapters, connectors, buttons, routers, speakers, display screens, GUIs, and/or touch screen GUIs, etc., that can facilitate enabling the TMC 300 to interface and/or communicate with other systems or components, such as communication devices and/or a communication network(s). For instance, the interface component 304 can comprise all or a portion of the components, features, or functionality, as described with regard to UI component 204 in FIG. 2, as disclosed herein.

In still another aspect, the TMC 300 can include an analyzer component 306 that can analyze or parse information, including information relating to fund transfers, registration of users, log in or authentication of users, account information, user profiles, etc., to identify or determine information contained in a fund transfer request, whether a user or associated communication device is registered with the TMC 300, whether a user is authenticated, a subset of access rights to grant to an authenticated user, an account to use during a fund transfer, whether to transfer funds from one account to another, whether to authorize a withdrawal of funds from an account, what information to include in a message or notification relating to a fund transfer, etc.

In another aspect, the TMC 300 can include a selector component 308 that can be employed to select information, an account, an amount of funds, a type of message to generate, a user profile, authentication credentials, etc., in relation to a fund transfer, a registration of a user or an account, or other event relating to the MTS. For example, the selector component 308 can select an account from which to withdraw funds with regard to a particular fund transfer based at least in part on user preferences and/or amount of available funds in the account. As another example, the selector component 308 can select a type of message to generate in relation to fund transfer based at least in part on user preferences relating to the fund transfer, whether the intended recipient is registered with the TMC 300, and/or other factors.

In yet another aspect, the TMC 300 can contain an application component 310 that can comprise one or more applications, including an MTS web application that can be made available to a user via a communication device to facilitate fund transfers, a user MTS mobile application that can be provided to a communication device of a user to provide additional functionality to the communication device relating to fund transfers with the TMC 300 to facilitate fund transfers with the TMC 300, an MTS mobile application that can be utilized by the TMC 300 in conjunction with the user MTS mobile application to facilitate fund transfers, a messaging application that can be employed by the TMC 300 to generate, transmit or receive messages of various types (e.g., text message, email message, MTS message, IM, multimedia message, voice mail message, etc.) in relation to the MTS, a financial transaction application that can facilitate performing functions relating to financial transactions, an authentication application to facilitate authenticating users, a cryptographic application to facilitate performing cryptographic functions, a registration application to facilitate registration of users to use the MTS and register associated accounts of the users, etc. In another aspect, the TMC 300 can include a message generator 312, which can operate in conjunction with one or more messaging applications, to generate, transmit or receive messages, including facilitating inputting information into messages.

In yet another aspect, the TMC 300 can contain a registration component 314 that can be employed to register users and register accounts associated with users to facilitate enabling the users to use the MTS. In another aspect, the TMC 300 can employ an account management component 316 that can operate in conjunction with the registration component 314 and transaction management component 318, to facilitate registering an account of a user, modifying information relating to an account of a user, managing a service account (e.g., MTS account) of a user, managing interaction (e.g., withdrawals, deposits) with other accounts (e.g., bank accounts, credit card accounts, utility accounts, etc.) associated with the user, etc.

In an aspect, the TMC 300 can include the transaction management component 318, which can operate in conjunction with the other components of the TMC 300 to control fund transfers between communication devices, control withdrawals from or deposits to an account associated with a user in relation to a fund transfer, control access to an account of a user, control the generation of a message or notification relating to a fund transfer, control processing of a fund transfer request, control processing of a transfer of funds in response to receiving an indication that an intended recipient is accepting the fund transfer, control the generation of a token, etc.

In yet another aspect, the TMC 300 can include a token generator 320 that, when desired, can be employed to generate a token, such as a secure token, that can comprise or be associated with a specified amount of monetary funds, wherein the token can be included in a message to send funds to another communication device associated with the intended recipient as part of a transfer fund request. For example, monetary funds can be embedded or represented in an electronic form (e.g., data) in a secure token, wherein the secure token can be presented and used like physical money (e.g., paper money) by the intended recipient when received by the communication device of the intended recipient. In an aspect, a secured token can be secured using authentication protocols and cryptographic protocols to ensure that the secure token, and/or the embedded funds (when funds are embedded in the secure token), is only able to be accessed by an authorized entity (e.g., intended recipient, TMC).

In accordance with various aspects, the TMC 300 can contain a security component 322 that can secure information relating to fund transfers and messages. The security component 322 can employ authentication protocols and cryptographic protocols (e.g., protocol relating to data encryption and decryption, public key cryptography, symmetric key, Public key infrastructure (PKI), Digital Signature Standard (DSS), Data Encryption Standard (DES), triple-DES, Advanced Encryption Standard (AES), cryptographic hash functions, etc.) to facilitate securing messages relating to fund transfers, communications between the TMC 300 and a communication device (e.g., communication device transferring funds, communication device receiving funds, communication device associated with a third-party account, etc.), securing information relating to secure tokens, etc. The security component 322 can use a desired cryptographic protocol to encrypt voice or data for transmission and decrypt voice or data when received. The security component 322 can employ a desired authentication protocol(s) to control access to an account associated with a user, a user profile, a fund transfer, a secure token (e.g. lock or unlock a secure token, encrypt or decrypt data associated with a secure token), etc., to grant access to an authorized entity (e.g., intended recipient, payee) and deny access to an unauthorized entity, as more fully described herein.

In yet another aspect, the TMC 300 can comprise a processor component 324 that can work in conjunction with the other components (e.g., communicator component 302, interface component 304, analyzer component 306, etc.) to facilitate performing the various functions of the TMC 300. The processor component 324 can employ one or more processors, microprocessors, or controllers that can process data, such as information relating to fund transfers, user profiles, user preferences, accounts associated with users, authentication, encryption or decryption, tokens, operations of the TMC 300, and/or other information, etc., to facilitate operation of the TMC 300, as more fully disclosed herein, and control data flow between the TMC 300 and other components (e.g., communication device, communication network, etc.) associated with the TMC 300.

The TMC 300 also can include a data store 326 that can store data structures (e.g., user data, metadata), code structure(s) (e.g., modules, objects, hashes, classes, procedures) or instructions, information relating to fund transfers, user profiles, user preferences, accounts associated with users, authentication, encryption or decryption, tokens, operations of the TMC 300, and/or other information, etc., to facilitate controlling operations associated with the TMC 300. In an aspect, the processor component 324 can be functionally coupled (e.g., through a memory bus) to the data store 326 in order to store and retrieve information desired to operate and/or confer functionality, at least in part, to the communicator component 302, interface component 304, analyzer component 306, etc., and/or substantially any other operational aspects of the TMC 300.

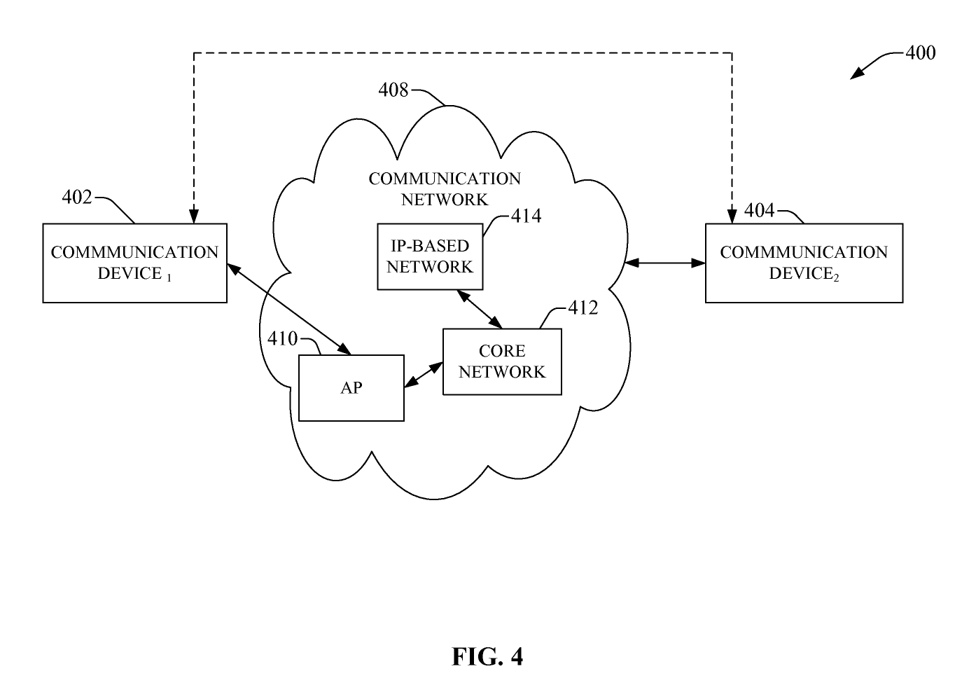

FIG. 4 illustrates a diagram of an example system 400 that can facilitate money transfers in accordance with various aspects and embodiments of the disclosed subject matter. In an aspect, the system 400 can include a plurality of communication devices, including a first communication device 402 (also referred to as communication device₁) and a second communication device 404 (also referred to as communication device₂) that can communicate (e.g., voice, data) with each other or other communication devices (e.g., TMC) associated with the system 400. The system 400 can include a TMC 406 that can be associated with an MTS (not shown in FIG. 4) and can control fund transfers between communication devices and associated communication device users, as more fully described herein.

In another aspect, the system 400 can comprise a communication network 408 that can be employed to facilitate communication of voice and data between the first communication device 402, second communication device 404, TMC 406, or other communication devices associated with the communication network 408. Each of the communication devices can connect to the communication network 408 via a wireline or wireless communication connection. The communication network 408 can comprise or be associated with a number of access points (APs) (e.g., base station), including AP 410, wherein the AP 410 can facilitate wireless connection of a communication device (e.g., 402) with the communication network 408, when a wireless connection is desired.

In accordance with various aspects, as a communication device (e.g., 402) is moved through a wireless communication network environment, at various times, the communication device can be connected (e.g., wirelessly connected) to one of a plurality of APs (e.g., macro or cellular AP, femto AP, pico AP, Wi-Fi AP, Wi-Max AP, etc.), such as the AP 410, that can operate in the wireless communication network environment. An AP (e.g., 410) can serve a specified coverage area to facilitate communication by the communication device or other communication devices in the wireless communication network environment. The AP can serve a respective coverage cell (e.g., macrocell, femtocell, picocell, etc.) that can cover a respective specified area, and the AP can service mobile wireless devices (e.g., communication device 402) located in the respective area covered by the respective cell, where such coverage can be achieved via a wireless link (e.g., uplink (UL), downlink (DL)). When an attachment attempt is successful, the communication device can be served by the AP and incoming voice and data traffic can be paged and routed to the communication device through the AP, and outgoing voice and data traffic from the communication device can be paged and routed through the AP to other communication devices in the communication network environment. In an aspect, the communication device can be connected and can communicate wirelessly using virtually any desired wireless technology, including, for example, cellular, Wi-Fi, Wi-Max, wireless local area networks (WLAN), etc.

In another aspect, the communication network 408 can comprise a core network 412 (e.g., mobile core network) that can be employed to facilitate communication (e.g., voice, data) by wireless communication devices (e.g., 402) associated (e.g., wirelessly connected) with the core network 412, via the AP 410, and other communication devices (e.g., 404) associated with the communication network 408. The core network 412 can facilitate routing voice and data communications between communication devices (e.g., TMC, phone, computer, server, multimedia server, audio server, video server, news server, financial or stock information server, other communication devices associated with an IP-based network 414 (e.g., the Internet), etc.) associated with the communication network 408. The core network 412 also can allocate resources to the a wireless communication device(s) (e.g., 402) associated with the core network 412, convert or enforce protocols, establish and enforce Quality of Service (QoS) for the wireless communication devices, provide applications or services in the network, translate signals, and/or perform other desired functions to facilitate system interoperability and communication in the wireless communication network. The core network 412 further can include desired components, such as routers, nodes, switches, interfaces, controllers, etc., that can facilitate communication of data between communication devices associated with the communication network 408.

The communication network 408 also can include the IP-based network 414 that can be associated with the core network 412 and can facilitate communications by communication devices associated with the communication network 408 at least in part via communication of data packets (e.g., IP-based data packets) between communication devices that are associated with the communication network 408 using a wired or wireless communication connection in accordance with specified IP protocols. The IP-based network 414 further can include desired components, such as routers, nodes, switches, interfaces, controllers, etc., that can facilitate communication of data between communication devices associated with the communication network 408. In an aspect, a wireline communication connection between a communication device (e.g., communication device 404, TMC 406) and the IP-based network 414 can be a communication connection that can communicate voice or data, and/or can be a DSL-type or broadband connection facilitated via an Ethernet connection, and/or a wireless communication connection can be facilitated via a connection of the wireless communication device to an AP (e.g., 410). In accordance with various aspects, the communication device can transmit voice calls or data (e.g., messages) via a wireline or wireless connection through the IP-based network 414, the core network 412, or other communication networks, to other communication devices.

In accordance with yet another aspect, the first communication device 402 and second communication device 404 can establish a direct communication channel with each other to exchange information, such as information relating to fund transfers (e.g., fund transfer message, secure token, etc.), using NFC or other communication technology, as more fully described herein.

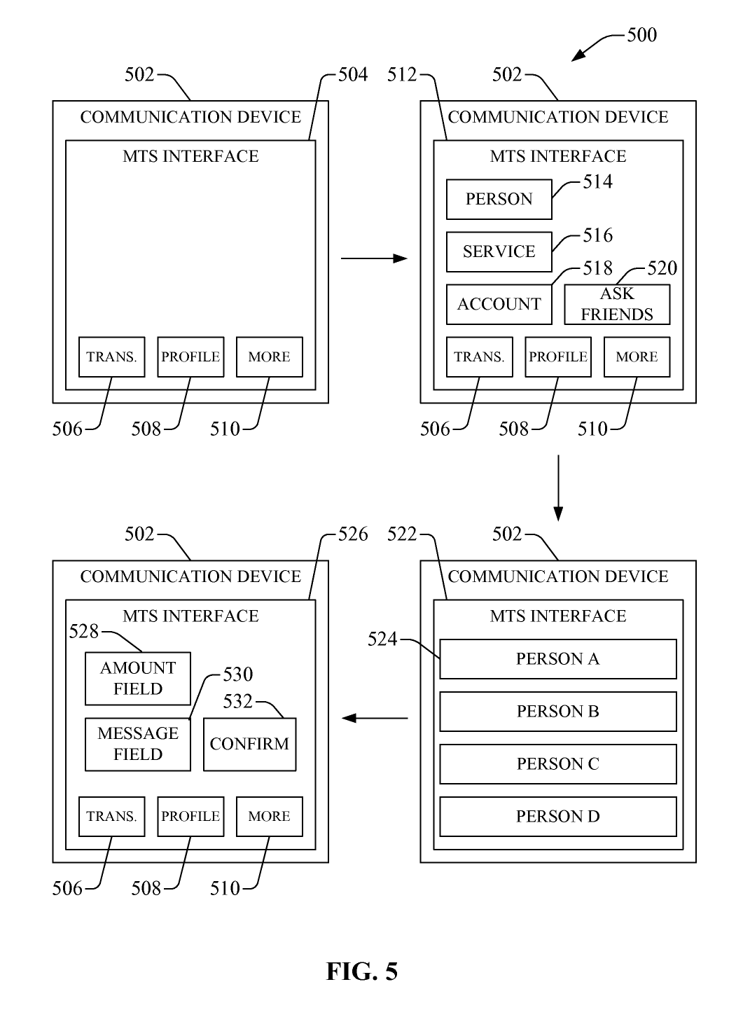

FIG. 5 presents a diagram of an example fund transfer message generation flow 500 that can facilitate generating and sending a fund transfer request (e.g., MTS fund transfer request) using a web or mobile MTS application interface in accordance with various aspects of the disclosed subject matter. In the example fund transfer message generation flow 500, the communication device 502 can employ a web or mobile MTS application to generate and transmit a fund transfer request. The mobile TMC (not shown in FIG. 5) on the communication device 502 can control the process of generating and sending a fund transfer request. The user can be authenticated before being able to access at least portions of the information secured by the web or mobile MTS application.

When the web or mobile MTS application is opened or accessed by the communication device 502, an MTS interface 504 can be displayed wherein the MTS interface can comprise a plurality of controls, such as, for example, a transfer control 506 that can be selected to facilitate generating a fund transfer request, a profile control 508 that can be selected to access, display or modify information in a user profile associated with the communication device user, and/or a more control 510 that can be selected to display additional controls or features of the web or mobile MTS application. The user can select the transfer control 506 to create a new fund transfer request.

In response to the selection of the transfer control 506, the web or mobile MTS application can display a plurality of controls relating to generating the fund transfer request, wherein the plurality of controls can include, for example, a person control 514 (e.g., contact list control) that can be selected to display the contact list, a service control 516 that can be employed to display available services associated with the MTS, an account control 518 that can display information regarding the service account or other accounts the user has registered with the TMC of the MTS, and/or an ask-friends-for-money control 520 that can be used to generate and send a message to a friend to request money from the friend. The user can select the person control 514 to view the contact list.

In response to the selection of the person control 514, the application can display the contact list 522 (e.g., stored on the communication device 502, or stored on the TMC), which can comprise a plurality of contacts associated with the user. The user can select a desired contact, such as Person A 524, and, in response, the mobile TMC can update the fund transfer request to include Person A 524 and information relating to Person A 524 in the fund transfer request. Further, in response to the selection of the person control 514, the mobile TMC can display a message 526 (e.g., MTS message) in the application interface that indicates that Person A 524 is the intended recipient of the fund transfer. The application interface also can comprise, for example, an amount field 528 wherein the desired amount to be transferred can be entered by the user, a message field 530 wherein the user can enter a personal message to the intended recipient, if desired, and/or a confirm control 532 that can be used to confirm the information in the fund transfer request and/or transmit the fund transfer request. In response to selection of the selection of the confirm control 532 and/or a send transfer request control (not shown), the fund transfer request can be submitted to the TMC of the MTS for processing of the fund transfer request.

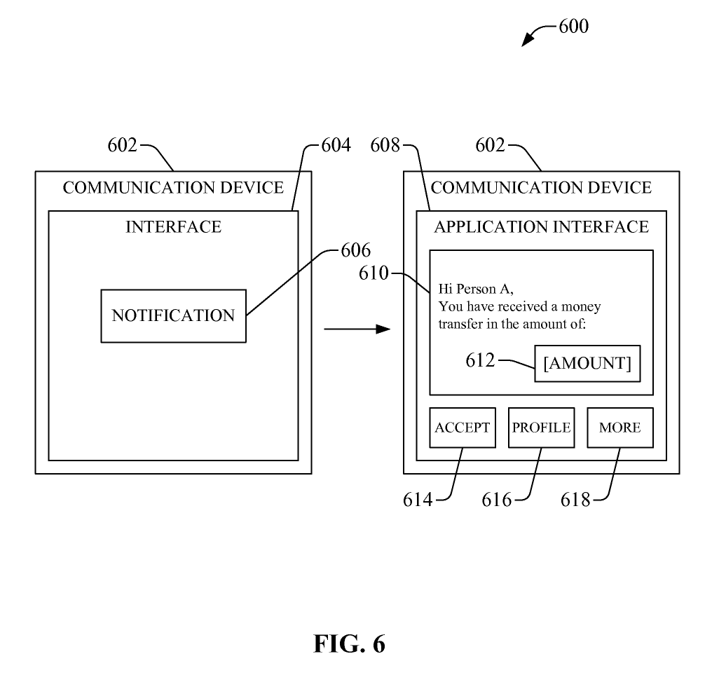

FIG. 6 illustrates a block diagram of an example fund transfer message receipt flow 600 that can facilitate receiving and obtaining funds associated with a fund transfer message (e.g., MTS fund transfer message) using a web or mobile MTS application interface in accordance with various aspects of the disclosed subject matter. In the example fund transfer message receipt flow 600, the communication device 602 can employ a web or mobile MTS application to display and interact with a received fund transfer message. The mobile TMC (not shown in FIG. 6) on the communication device 602 can control the process of obtaining, withdrawing, or depositing of funds received as part of the fund transfer message. The user can be authenticated before being able to access at least portions of the information secured by the web or mobile MTS application.

The TMC of the MTS can transmit the fund transfer message to the communication device 602. An interface 604 on the communication device 602 can present (e.g., display) a fund transfer notification 606 to the user. The user can select the notification 606, and, in response, the mobile TMC can open the web or mobile MTS application and/or request the user to authenticate (if this is not already done). When the application is opened, the mobile TMC can display an application interface 608 that can comprise a fund transfer message 610 comprising information notifying the intended recipient (e.g., Person A) that funds have been transferred to the intended recipient and can specify the fund amount 612. The application interface 608 also can include a plurality of controls, such as, for example, an accept money control 614 (also referred to as “ACCEPT” in FIG. 6) that can be selected to accept the fund transfer and/or take other desired action with regard to the transferred funds (e.g., withdraw funds, deposit funds, pay bill with funds, etc.), a profile control 616 that can be selected to access, display or modify information in a user profile associated with the intended recipient, and/or a more control 618 that can be selected to display additional controls or features of the web or mobile MTS application.

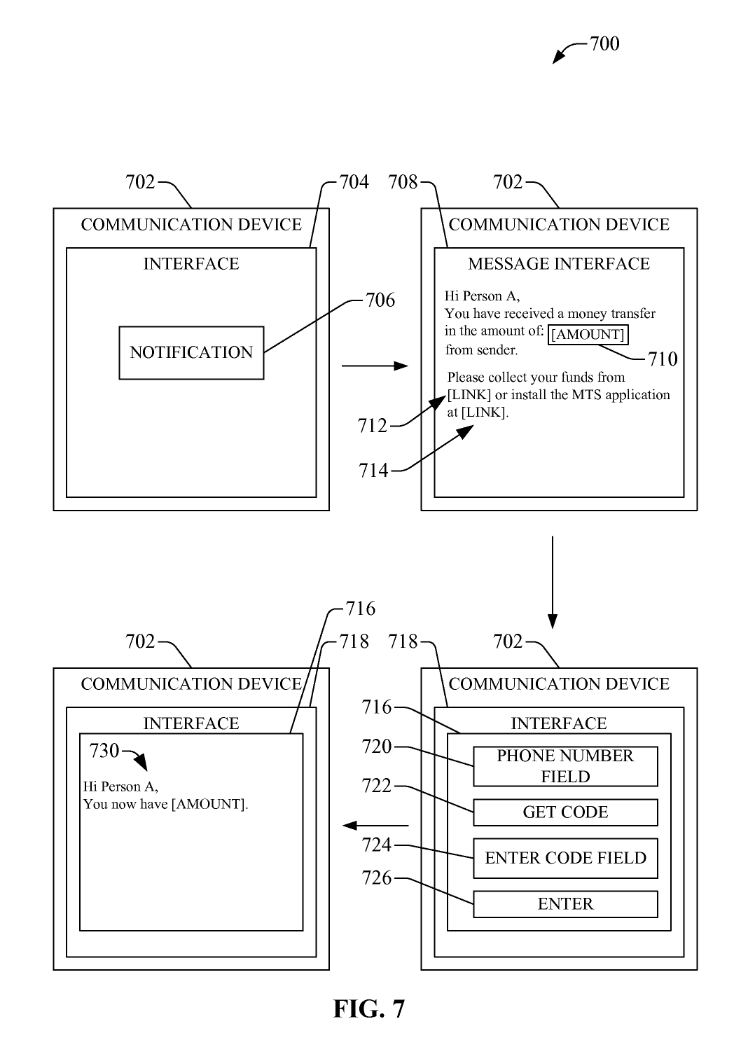

FIG. 7 depicts a block diagram of an example fund transfer message receipt flow 700 that can facilitate receiving and obtaining funds associated with a fund transfer message using a message application interface in accordance with various aspects of the disclosed subject matter. In the example fund transfer message receipt flow 700, the communication device 702 can employ a message application and interface to display and interact with a received fund transfer message (e.g., text, IM, multimedia, or email message). The communication device 702 can control the process of obtaining, withdrawing, or depositing of funds received as part of the fund transfer message.

The TMC of the MTS can transmit the fund transfer message (e.g., text, IM, multimedia, or email message) to the communication device 702. An interface 704, which can be a main interface or a message application interface, on the communication device 702 can present (e.g., display) a fund transfer notification 706 to the user. The user can select the notification 706, and, in response, the communication device 702 can open the message application and/or request the user to authenticate (if this is not already done). When the message application is opened, the communication device 702 can display a message interface 708 that can comprise a fund transfer message for the intended recipient (e.g., Person A), wherein the fund transfer message can comprise information indicating that funds have been transferred to the intended recipient and can specify the fund amount 710. The fund transfer message also can include a link 712 that can be used to accept and/or obtain the fund transfer, wherein the link 712 can be a unique link (e.g., unique hyperlink) to a web page associated with the TMC of the MTS, wherein the web page can comprise information and controls that can facilitate enabling the intended recipient to accept, obtain and/or take another desired action with regard to the transferred funds, and/or the message can request the intended recipient to download the MTS application and can include a link 714 that can open up an online page (e.g., web page) that can be associated with or can include a download control that can be used to download the MTS application on the communication device 702, if desired by the intended recipient.

In an aspect, in response to the intended recipient selecting the link 712 in the message interface, the communication device 702 can open the online page 716 associated with the link 712 and can present the online page 716 in an interface 718 to the intended recipient, wherein the interface 718 can be a message interface or a web browser interface. The online page 716 can comprise information that can facilitate enabling the intended recipient to obtain the funds and/or can require that the intended recipient validate or authenticate with the TMC of the MTS to prove the communication device 702 is the device associated with the intended recipient of the funds transfer request and/or the intended recipient is authorized to obtain the funds. For example, the interface 718 can comprise a phone number field 720 (or email address field, if the message was sent to the email) and the TMC can require that the intended recipient enter the phone number (or email address, if the message was sent to the email) of the communication device 702; can include a code control 722 that, when selected by the intended recipient in the interface 718, can result in the TMC sending a validation or authorization code to the phone number (or email address) in the phone number field 720 (or email address field); and can include an enter code field 724 wherein the intended recipient can enter the validation or authorization code received by the communication device 702 from the TMC. The online page 718 also can contain an enter control 726, and the intended recipient can select the enter control field after the required information has been input to the specified fields. In response to validating, authenticating or authorizing the intended recipient (e.g., upon receipt of a valid phone number or email address, and a proper validation or authorization code), the TMC can authorize the intended recipient to obtain the transferred funds. The online page 716 (or another online page) can present a message 730 to the intended recipient that indicates the amount of funds the intended recipient has available. The intended recipient, via the online page 718 or another online page associated with the TMC, can provide the TMC with information, such as account information of the intended recipient, and the TMC can transfer the funds to the account or other destination specified by the intended recipient, or the intended recipient can request that the TMC transmit a secure token, comprising the funds or information enabling the secure token to be used to access the funds, to the communication device 702 or another desired destination (e.g., email the secure token to the intended recipient's email address). When a secure token is provided to the intended recipient, the intended recipient can use the secure token in a manner as more fully described herein.

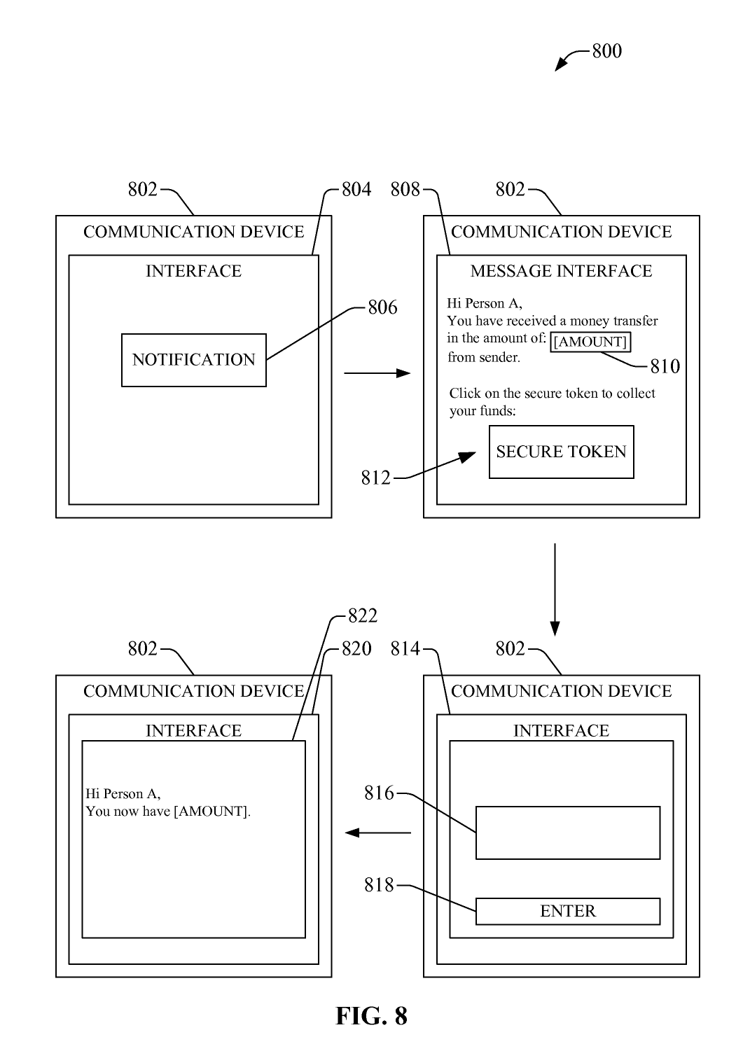

FIG. 8 presents a block diagram of an example fund transfer message receipt flow 800 that can facilitate receiving and obtaining funds associated with a fund transfer message comprising a secure token using a message application interface in accordance with various aspects of the disclosed subject matter. In the example fund transfer message receipt flow 800, the communication device 802 can employ a message application and interface to display and interact with a received fund transfer message (e.g., text, IM, multimedia, or email message). The communication device 802 can control the process of obtaining, withdrawing, or depositing of funds received as part of the fund transfer message.

The TMC of the MTS can transmit the fund transfer message (e.g., text, IM, multimedia, or email message) to the communication device 802. An interface 804, which can be a main interface or a message application interface, on the communication device 802 can present (e.g., display) a fund transfer notification 806 to the user, wherein the notification 806 can be employed to inform the communication device user (e.g., intended recipient) that a fund transfer message has been received. The user can select the notification 806, and, in response, the communication device 802 can open the message application and/or request the user to authenticate (e.g., enter a pass code to access a communication device interface if this is required and not already done). When the message application is opened, the communication device 802 can display a message interface 808 that can comprise a fund transfer message for the intended recipient (e.g., Person A), wherein the fund transfer message can comprise information indicating that funds have been transferred to the intended recipient and can specify the fund amount 810. The fund transfer message also can include a secure token 812 that can be used to accept and/or obtain the fund transfer, wherein the secure token 812 can comprise the transferred funds in an electronic form. The secure token 812 can be contained or embedded in the fund transfer message or can be an attachment to the fund transfer message.

In an aspect, in response to the intended recipient selecting the secure token 812 in the message interface 808, the communication device 802 can open an interface 814, which can be an interface (e.g., application interface) associated with the secure token 812. The interface 814 can contain information requesting the intended recipient to enter validation or authentication information (e.g., password, pass code, challenge-response, authentication image, biometric authentication credentials, etc.), and can contain a field 816 into which the validation or authentication information can be entered. Once such information is entered in the field 816, the intended recipient can press the enter control 818, and, if the validation or authentication information is valid, the secure token 812 can be unlocked and/or the information (e.g., transferred funds) therein can be decrypted and made available to the intended recipient; if the validation or authentication information is determined to not be valid, the secure token 812 or associated application can deny access to the secure token 812 and information therein (e.g., the secure token 812 can remain locked and/or the information (e.g., transferred funds) therein can remain encrypted). When the secure token 812 has been unlocked and/or its information decrypted, an interface 820 on the communication device 802 can present a message 822 to the intended recipient informing the user of the amount of funds the intended recipient has available.

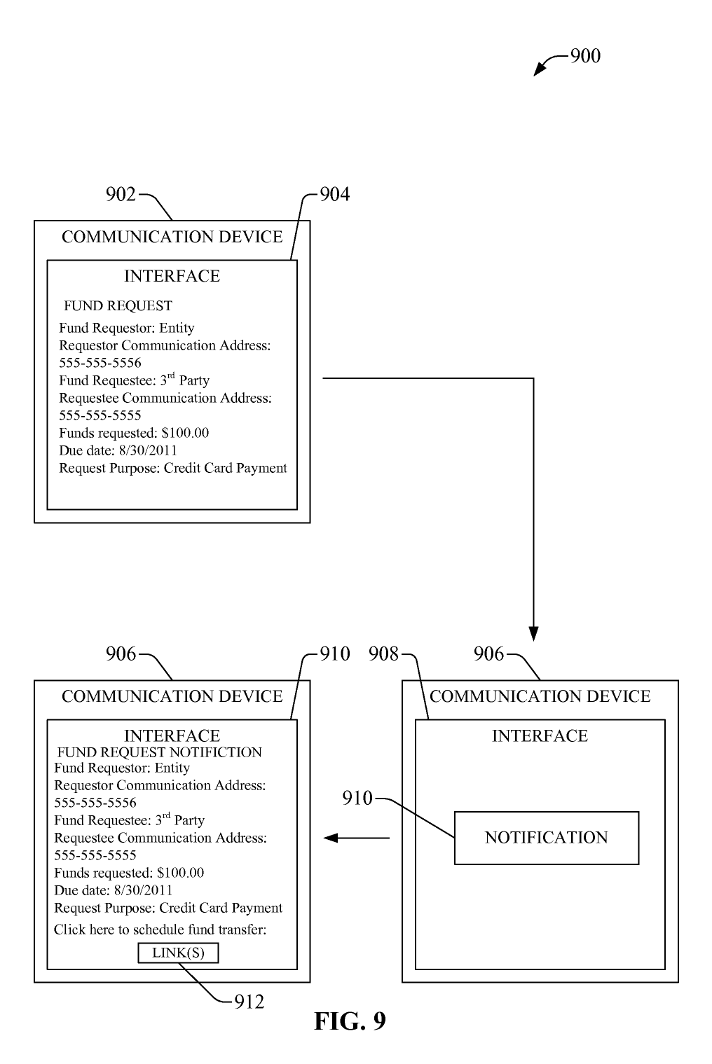

FIG. 9 depicts a block diagram of an example message flow 900 relating to a fund request in accordance with various aspects. In accordance with the message flow 900, a communication device 902 of the fund requestor can be utilized to generate a fund request message 904 comprising information, such as the name of the entity from whom the funds are requested, a communication address of the entity, a communication address of the fund requestor to which the funds can be sent, the amount of funds requested, the name of the fund requestor, a personal message, and/or other information. The fund request message 904 can presented to the TMC or the communication address associated with the entity from which the funds are being requested.

When the communication device 906 receives the fund request message 904 or a corresponding message from the TMC, an interface 908 can present the notification 910 of the message to the recipient of the fund request message. The recipient can access the fund request message by, for example, selecting the notification or opening a message application. The communication device 906 can present the message in an interface 910 to the recipient. The message can comprise information requesting the recipient to transfer or pay a specified amount of funds to the fund requestor at a communication address of the fund requestor. The message also can include a link(s) 912 that can enable the recipient to schedule a fund transfer to the fund requestor via the TMC, wherein the recipient can either register with the TMC or can remain unregistered but provide the TMC with account information and an authorization to withdraw funds from the recipient's account; can enable the recipient to download an MTS application (e.g., full version for registered or unregistered users; light version for unregistered users) onto the communication device 906 to facilitate fund transfers, including a fund transfer to the fund requestor. The funds can be transferred to the fund requestor in accordance with a date or time specified by the recipient of the fund request.

The aforementioned systems and/or devices have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component providing aggregate functionality. The components may also interact with one or more other components not specifically described herein for the sake of brevity, but known by those of skill in the art.

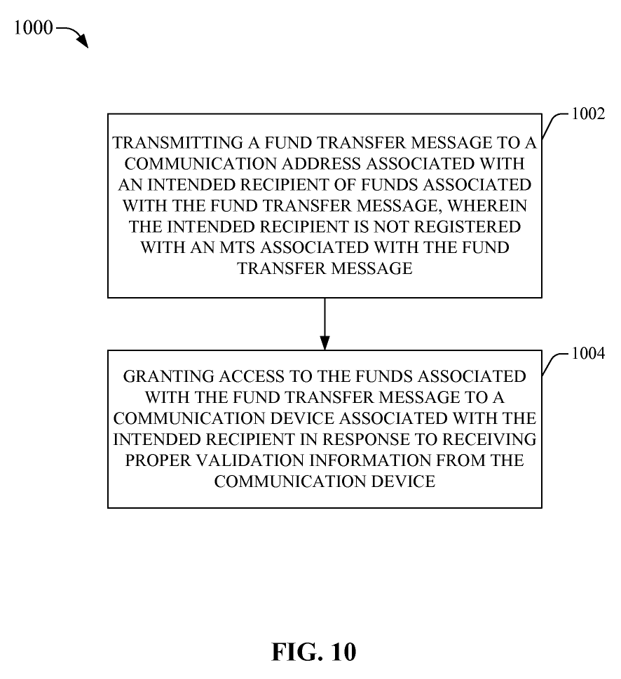

In view of the example systems described above, example methods that can be implemented in accordance with the disclosed subject matter can be better appreciated with reference to flowcharts in FIGS. 10-19. For purposes of simplicity of explanation, various methods disclosed herein are presented and described as a series of acts; however, it is to be understood and appreciated that the subject disclosure is not limited by the order of acts, as some acts may occur in different order and/or concurrently with other acts from that shown and described herein. It is noted that not all illustrated acts may be required to implement a described method in accordance with the subject specification. In addition, for example, one or more methods disclosed herein could alternatively be represented as a series of interrelated states or events, such as in a state diagram. Moreover, interaction diagram(s) or call flow(s) represent several of the example methods disclosed herein in accordance with the described subject matter; particularly in instances when disparate entities, or functional elements, enact disparate portions of one or more of the several methods. Furthermore, two or more of the disclosed example methods can be implemented in combination, to accomplish one or more features or advantages described in the subject disclosure.

With reference first to FIG. 10, illustrated is a flow chart of an example method 1000 for verifying an intended recipient of funds in relation to an electronic fund transfer in accordance with various aspects and embodiments. At 1002, a fund transfer message can be transmitted to a communication address (e.g., phone number, email address, messaging address associated with an online social networking site) associated with an intended recipient of funds associated with the fund transfer message, wherein the intended recipient is not registered with an MTS associated with the fund transfer message. The fund transfer message (e.g., an MTS message, a text message, an IM, a multimedia message, an email message, or a voice mail message, etc.) can be generated by, for example, the TMC, in response to a fund transfer request received from a fund sender via a communication device (e.g., 102). The fund transfer can be directed to the intended recipient (e.g., communication address associated with the intended recipient) and/or a communication device associated therewith, even if the intended recipient is not registered with the TMC or associated MTS. In an aspect, the fund transfer message can comprise, for example, a link to an online page associated with the TMC, or a secure token, that can facilitate verifying the intended recipient and/or associated communication device and providing the funds to the intended recipient, even when the intended recipient is not registered with the TMC and associated MTS.

At 1004, access to the funds associated with the fund transfer message can be granted to a communication device associated with the intended recipient in response to receiving proper validation information from the communication device. In accordance with various aspects and embodiments, the proper validation information can be a proper code (e.g., validation, authentication or authorization code), a valid response to a challenge, a valid image relating to a challenge image, etc. For instance, the intended recipient can utilize the associated communication device to communicate the proper validation information to the TMC to gain access to the transferred funds, in response to the communication device receiving the fund transfer message.

In an aspect, if the message comprises a link that can be used to obtain the specified amount of funds, the intended recipient can use the second communication device to select the link and, in response, an online page associated with the link can be opened and displayed on an interface (e.g., web browser interface) of the second communication device. The online page can request the intended recipient present an address (e.g., phone number, email address) associated with the second communication device and/or a code (e.g., validation, authorization or authentication code), wherein the code can be sent by the TMC to the second communication device at the address presented by the intended recipient via the second communication device. The TMC can authorize the intended recipient to obtain the transferred funds when the intended recipient presents a valid code.

In another aspect, if the message comprises a secure token that includes the transferred funds, the intended recipient can obtain the funds by providing valid authentication information to the secure token or application associated therewith, wherein the authentication information can be received from the first user or the TMC or known by the intended recipient, or can be information known to the intended recipient. For example, the first user via the first communication device and/or TMC can secure the secure token using a desired code (e.g., password, challenge and response, PIN, etc.), which the first user can send to the intended recipient (e.g., at the second communication device) via a separate message or which can be previously known by the intended recipient, or the TMC can generate the code or key and secure the secure token using the code or key (e.g., to lock the secure token and/or encrypt the data contained in the secure token). The intended recipient, using the second communication device, can select the secure token, and the secure token can request that a proper code or key be entered in order to unlock the secure token (and transferred funds therein) and/or decrypt the data, including data relating to the transferred funds, contained in the secure token. The secure token can be unlocked and/or its data decrypted, when the proper code or key is entered, and the funds can be available on the second communication device for use by the intended recipient.

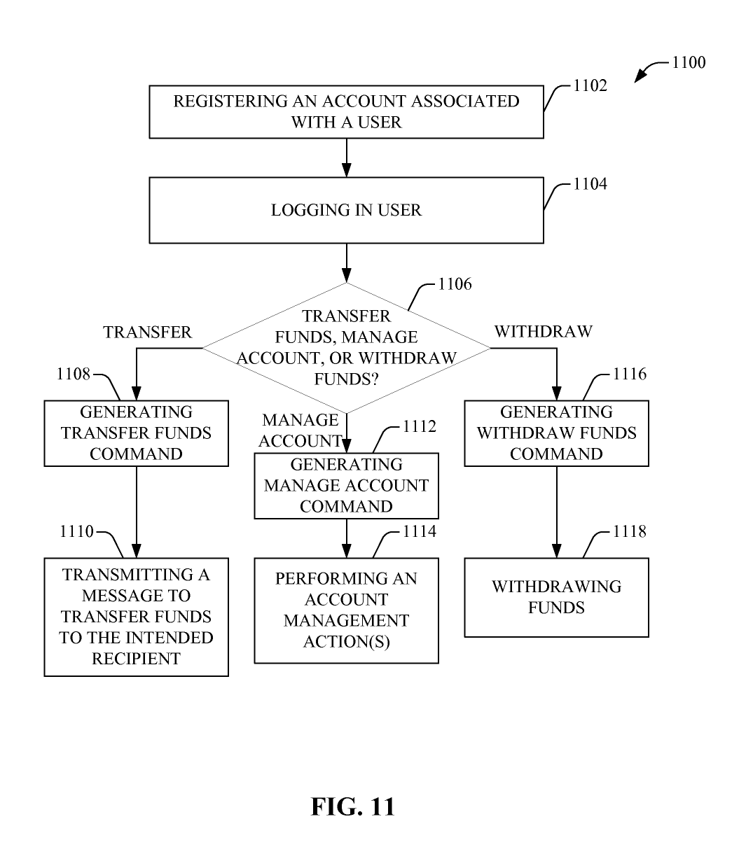

Referring next to FIG. 11, depicted is a flow chart of an example a method 1100 for managing fund transfers in accordance with various aspects and embodiments. At 1102, an account associated with a user can be registered. For example, a user can use a communication device to register an account that can be used to transfer money or receive money. As part of the registration of the user, authentication credentials, such as, for example, a username, password, passphrase, personal identification number (PIN), unique biometric information associated with the user can be created by the user and/or TMC, and stored by the TMC. The stored authentication credentials associated with the user can be used during a login process to authenticate or verify the user and to determine access rights to be granted to the user in relation to financial transfers associated with the transaction system.

At 1104, the user can be logged in to the TMC in response to receiving valid authentication credentials from the user. The user can use a communication device to enter authentication credentials via an application interface or online (e.g., web) interface, and the authentication credentials can be transmitted to the TMC to log into the transaction system. At 1106, a determination can be made as to whether to transfer (e.g., send) funds, view or manage the account, or receive funds.

If, at 1106, the determination is to transfer funds, at 1108, a transfer funds command can be generated. For instance, in response to selection of a transfer funds control on the communication device by the user, a transfer funds command can be generated. Other information, such as the amount of funds, the intended recipient and associated address information can be selected on or received by the communication device, as part of the transfer funds transaction. At 1110, a message to transfer funds to the intended recipient can be transmitted. The user can employ the communication device to generate and transmit a message, such as an instant message, a text message, a notification via a web or mobile application, or an MTS message, etc., from the communication device to an intended destination, which can be an address (e.g., email address, phone number, account number, IP address, etc.) associated with or accessible by a communication device of the intended recipient. The message can include information indicating the amount of funds being transferred to the intended recipient. The TMC can manage the sending of funds to the intended recipient, wherein the transfer management component can receive the message from the sending communication device and/or can generate a corresponding message that can be forwarded to the address of the intended recipient.

Referring again to act 1106, if, at 1106, the determination is to view or manage the account, at 1112, a manage account funds command can be generated. For instance, in response to selection of a view or manage account control on the communication device by the user, a view or manage account command can be generated and transmitted to the TMC. At 1114, one or more account management actions can be performed. For example, the communication device can be used to transmit a request (e.g., one-time request) that funds be manually withdrawn or deposited into the account, and the TMC can receive the request and withdraw funds from or deposit funds into the account, wherein the funds can be provided to or received from, for example, another account, such as another account associated with the user. As another example, the communication device can be used to transmit a request that funds be automatically withdrawn or deposited into the account (e.g., on a periodic basis), and the TMC can receive the request and can set up the user's account to automatically withdraw funds from or deposit funds into the account, wherein the funds can be provided to or received from, for example, another account, such as another account associated with the user and registered with or accessible by the TMC. As still another example, the communication device can be used to transmit a request that add (e.g., register), remove, or modify an account, and the TMC can receive the request and can add, remove, or modify an account in accordance with the information provided by the user via the communication device as part of the request.

Referring again to act 1106, if, at 1106, the determination is to receive funds, at 1116, a receive funds command can be generated. For instance, in response to selection of a receive funds control (or withdraw funds control) on the communication device by the user, a receive funds command can be generated and sent to the TMC. The user can decide to transmit a receive funds request to receive or withdraw the funds sent to the user, for example, in response to receiving a message (e.g., an instant message, a text message, a notification via a web or mobile application, or an MTS message, etc.) indicating that the user has been sent a specified amount of funds from a funds sender. At 1118, the desired amount of funds can be withdrawn, for example, from a service account (or other account) associated with the user. As desired, the method 1100 can return to act 1114 to deposit (e.g., manually or automatically) all or a portion of the received funds in an account associated with the user.

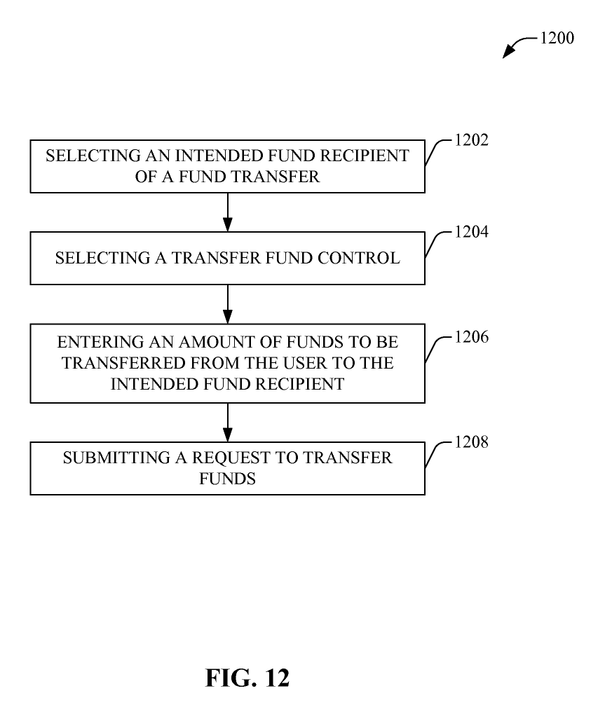

FIG. 12 illustrates a flow chart of an example method 1200 for sending funds via a message interface (e.g., IM interface, text message interface) associated with a service account associated with a user in accordance with various aspects and embodiments. At 1202, an intended fund recipient of a fund transfer can be selected. For instance, the communication device can receive information indicating selection of the intended fund recipient from the user via the UI and the mobile TMC of the communication device can select the intended fund recipient in response. At 1204, a transfer fund control can be selected. For instance, the communication device can receive selection of the transfer fund control from the user via the message interface or another UI.

At 1206, an amount of funds to be transferred from the user to the intended fund recipient can be entered. In an aspect, via a UI (e.g., message interface), the communication device can receive information indicating the amount of funds to be transferred from the service account of the user to the intended fund recipient via an address associated with the intended fund recipient, wherein such address can be associated with a service account or other account of the intended fund recipient or can be associated with a physical (e.g., geographical) address where the intended fund recipient can go to pick up the transferred funds. For example, the UI can generate and display a screen or menu, such as a pop-up screen or menu, that can provide a field for the user to enter the desired fund transfer amount and/or predefined fund transfer amounts (e.g., $20, $50, $100, . . . ) that can be selected via the UI, and the user can enter information indicating the desired fund transfer amount via the UI. At 1208, a request to transfer funds can be submitted (e.g., transmitted). In an aspect, the communication device can generate and transmit the request to transfer funds, comprising information relating to the intended fund recipient, and the amount of money, to the TMC and/or a communication device associated with the intended recipient.

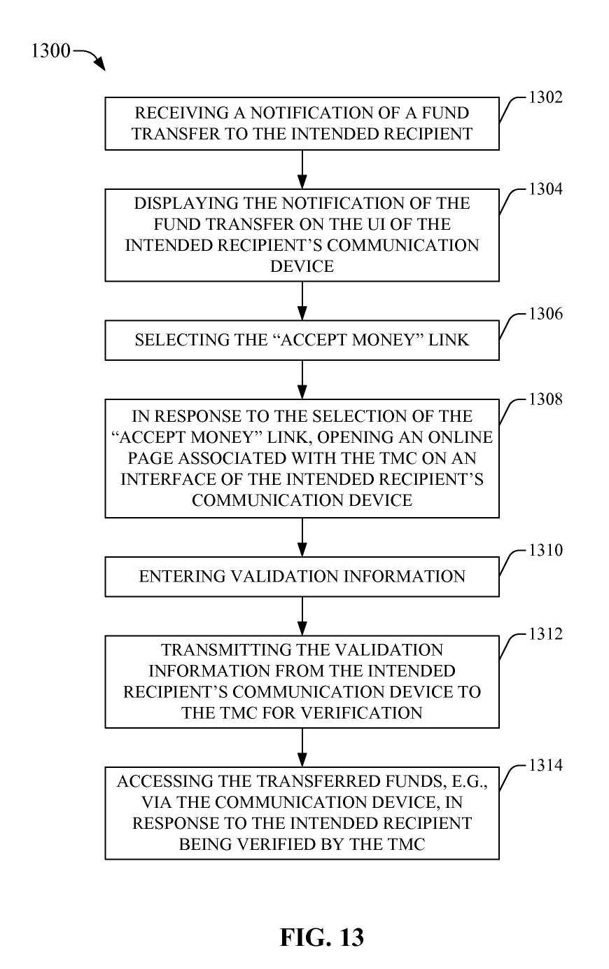

FIG. 13 illustrates a flow chart of an example method 1300 for receiving transferred funds via a message interface (e.g., IM interface, text message interface) on a communication device associated with an unregistered intended recipient in accordance with various aspects and embodiments. The method 1300 can be employed, for example, when funds are being transferred to the intended recipient via the TMC and associated MTS, and the intended recipient is not registered with the TMC.

At 1302, a notification of a fund transfer to the intended recipient can be received, for example, by the communication device of the intended recipient. The fund transfer can be sent via a fund transfer request from another communication device of another user who desires to send funds to the intended recipient, wherein the fund transfer request can be directed to a communication address (e.g., phone number, email address, intended recipient's social network address (e.g., social network messaging address) or online page) associated with the intended recipient and/or accessible by the intended recipient's communication device. At 1304, the notification of the fund transfer can be displayed on the UI (e.g., IM interface or text message interface of the UI) of the intended recipient's communication device. For example, the notification can be displayed in an IM conversation thread between the receiving user and the user who sent the funds. In an aspect, the notification can comprise an “accept money” link (e.g., hyperlink), such as an “accept money” URL link. At 1306, the “accept money” link can be selected. For instance, the communication device can receive information (e.g., input, selection, or gesture on the link or a receive fund transfer control on a touch screen GUI or other UI) via the UI indicating that the user selected the “accept money” link, and the communication device can select the “accept money” link in response to the received information.

At 1308, in response to the selection of the “accept money” link, an online page associated with the TMC can be opened on an interface of the intended recipient's communication device. The online page can be a validation page that can be used to validate or authenticate the intended recipient before allowing the intended recipient to access the transferred funds.

At 1310, validation information can be entered. At 1312, the validation information can be transmitted from the intended recipient's communication device to the TMC for verification. For example, the TMC can request that the intended recipient provide the communication address associated with the communication device. The intended recipient can enter the communication address and transmit that information to the TMC, along with requesting a code (e.g., validation code) from the TMC via selection of a “get code” control on the online page. The TMC can transmit the code to the communication address, and the code can be received or accessed by the intended recipient's communication device. The intended recipient can enter the code in a code field on the online page and can press an enter control to transmit the code to the TMC for verification.

At 1314, the transferred funds can be accessed, for example, via the communication device, in response to the intended recipient being verified by the TMC. In accordance with various aspects, since the intended recipient is not registered with the TMC, the TMC can make the funds available to the intended recipient via a temporary service account that can be associated with the intended recipient or by sending a token (e.g., secure token), comprising the funds in an electronic form, to the communication address of the intended recipient, and the intended recipient can access and use the funds, as more fully disclosed herein.

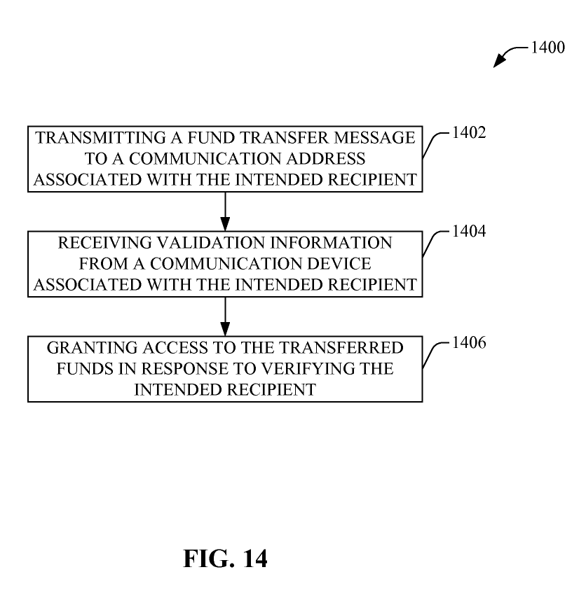

FIG. 14 depicts a flow chart of an example method 1400 for verifying an intended recipient of a fund transfer who is not registered with the TMC in accordance with various aspects and embodiments. At 1402, a fund transfer message can be transmitted to a communication address associated with the intended recipient (e.g., as specified in the fund transfer request). The fund transfer message can comprise a link to a verification page(s) associated with the TMC.

At 1404, validation information can be received from a communication device associated with the intended recipient. For instance, the TMC, via a verification page, can request that the intended recipient provide a communication address associated with or accessible by the intended recipient's communication device. The TMC can verify the communication address received from the intended recipient's communication device, and can transmit a validation code to the communication address. The intended recipient can enter the validation code into a code field on the verification page and can provide that validation code to the TMC (e.g., by pressing an enter control on the verification page). The TMC can analyze the validation code received from the intended recipient to identify whether the validation code matches the code provided to the intended recipient by the TMC; if there is a match, the TMC can deem the intended recipient verified and can allow the intended recipient access to the funds; and if there is no match, the TMC can deny the intended recipient access to the funds or can allow the intended recipient to attempt to be verified again up to a predefined maximum threshold number of verification or validation attempts.

At 1406, access to the transferred funds can be granted in response to verifying the intended recipient. Once verified, the TMC can allow the unregistered intended recipient to access the funds via a temporary service account that can be associated with the intended recipient or can transmit a token (e.g., secure token), comprising the funds in electronic form, to the communication address of the intended recipient, as more fully disclosed herein.

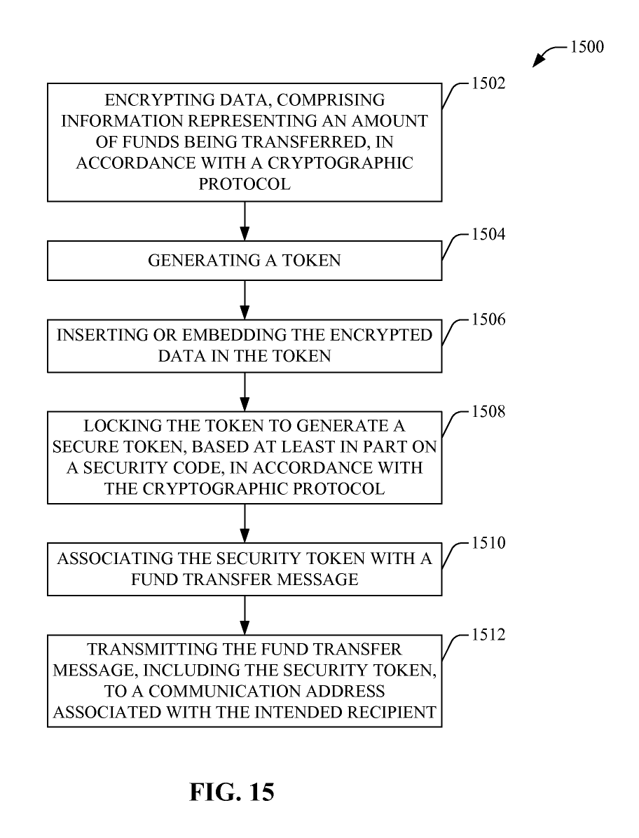

FIG. 15 presents a flow chart of an example method 1500 for generating a secure token comprising transferred funds in accordance with various aspects and embodiments. A secure token can be used to facilitate transferring funds to an intended recipient, for example, when the intended recipient is not registered with the TMC. The method 1500 can be employed, for example, by a communication device associated with fund sender or the TMC. At 1502, data, comprising information representing an amount of funds being transferred, can be encrypted in accordance with a cryptographic protocol. The funds can be money being transferred to an intended recipient, for example, as part of a fund transfer request. At 1504, a token can be generated. The token can be an electronic object or item that can comprise data. At 1506, the encrypted data can be inserted into or embedded in the token.

At 1508, the token can be locked to generate a secure token, based at least in part on a security code (e.g., validation code number or word; challenge-response; etc.), in accordance with the cryptographic protocol. The security code can be a number, word, phrase, or response (e.g., to a challenge) that can be known to the intended recipient of the funds associated with the security token. At 1510, the security token can be associated with (e.g., embedded in, attached to) a fund transfer message. At 1512, the fund transfer message, including the security token, can be transmitted to a communication address associated with the intended recipient.

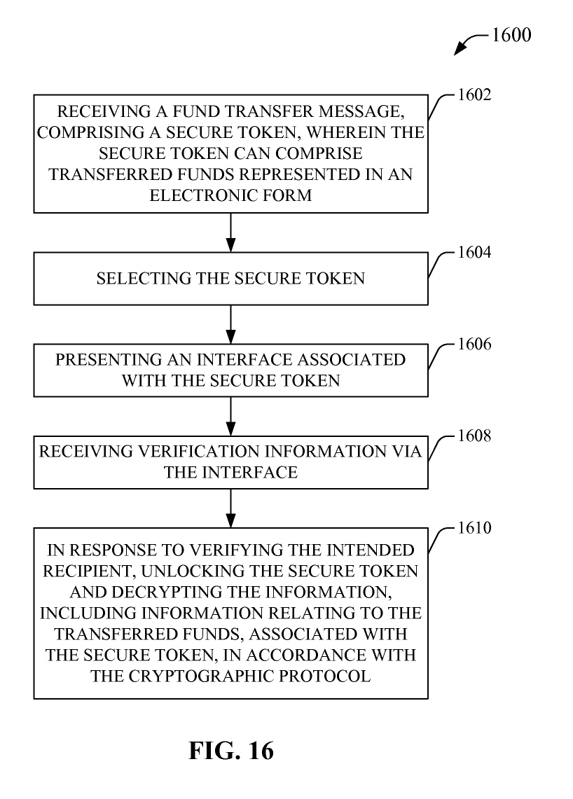

FIG. 16 illustrates a flow chart of an example method 1600 for gaining access to funds associated with a secure token in accordance with various aspects and embodiments. The method 1600 can be employed, for example, at least partially by a communication device associated with an intended recipient (e.g., unregistered intended recipient) of the funds. At 1602, a fund transfer message, comprising a secure token, can be received, wherein the secure token can comprise transferred funds represented in an electronic form. For instance, the fund transfer message can be received at a communication address associated with or accessible by the intended recipient's communication device.

At 1604, the secure token can be selected. For instance, the intended recipient, using the intended recipient's communication device, can select or manipulate the secure token to attempt to access or open the secure token. At 1606, an interface associated with the secure token can be presented. For instance, the secure token, or an application associated with the secure token, can generate and present an interface, such as a verification interface, on the UI of the communication device. The interface can comprise one or more fields (e.g., communication address field, security code field, etc.) into which verification information can be entered. The interface can prompt the intended recipient to enter verification information.

At 1608, verification information can be received via the interface. For instance, the intended recipient can use the communication device to enter verification information (e.g., security code number, word or phrase; response to a challenge; communication address associated with the intended recipient; etc.) into the field(s) on the interface. The intended recipient also can press an enter control or submit control to present the verification information to the secure token or associated application for processing. The secure token or associated application can analyze the submitted verification information and can compare it to stored verification information (e.g., stored in the secure token); if the submitted verification information matches the stored verification information, the intended recipient can be deemed verified by the secure token or associated application; and if the submitted verification information does not match the stored verification information, the intended recipient can be deemed unverified by the secure token or associated application, and can be denied access to the information in the secure token and/or can be prompted to attempt to verify again up to a predefined maximum threshold number of verification attempts, after which the intended recipient can be locked out of further verification attempts for at least a predefined amount of time or until a reset has been performed, or until a new secure token taking the place of the current token is received.

At 1610, in response to verifying the intended recipient, the secure token can be unlocked and the information, including information relating to the transferred funds, associated with the secure token can be decrypted, in accordance with the cryptographic protocol. At this point, the transferred funds, represented in an electronic form, can be accessed and used by the intended recipient. For instance, the intended recipient can present the funds via a UI on the communication device to an entity when purchasing a product or service from the entity; or the intended recipient can use the communication device to interface with an automatic teller machine (ATM) and can present the electronic object or information representing the funds to the ATM and can receive physical money back from the ATM in exchange.

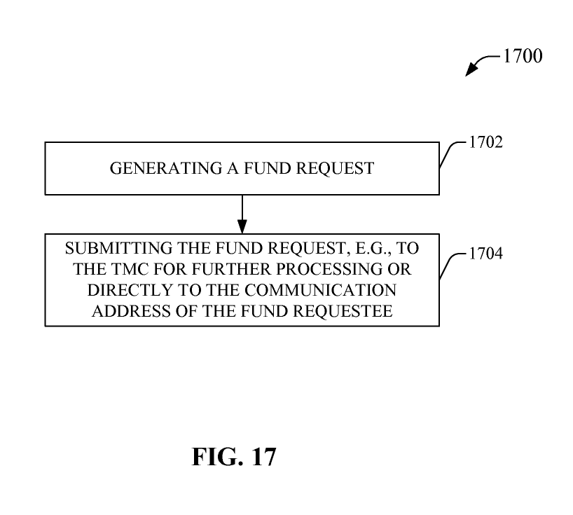

FIG. 17 depicts a flow chart of an example method 1700 for requesting funds from another entity in accordance with various aspects and embodiments. The method 1700 can be employed, for example, by a communication device associated with a fund requestor and/or the TMC. At 1702, a fund request can be generated. The fund requestor can use the fund requestor's communication device to generate the fund request on the communication device or the communication device can access an interface or request form on an online page presented by or associated with the TMC, and the fund request can be created using the online page. The fund request can comprise information, such as the name and/or communication address of the fund requestee, the name and/or communication address of the fund requestor, the amount of funds being requested, a desired due date for providing the requested funds, a personal message from the requestor to the requestee, verification information (e.g., information that the fund requestee is to use to secure a secure token when a secure token is used), and/or other information. The fund request can be for single payment or can be for multiple, regularly scheduled payments.

At 1704, the fund request can be submitted, for example, to the TMC for further processing or directly to the communication address of the fund requestee. For instance, the fund requestor can use the fund requestor's communication device to submit or transmit the fund request to the TMC, wherein the TMC can generate a fund request message or notification that can be sent to the communication address of the fund requestee. As another example, the fund requestor can use the fund requestor's communication device to submit or transmit the fund request, in the form of a text message, IM, email, multimedia message, etc., directly to the communication address of the fund requestee, bypassing the TMC.

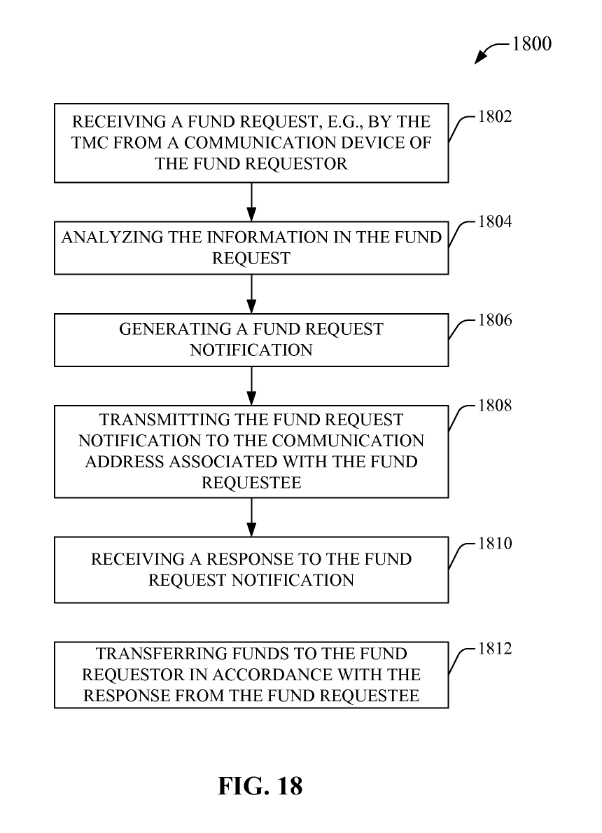

FIG. 18 illustrates a flow chart of an example method 1800 for managing and processing a fund request in accordance with various aspects and embodiments. The method 1800 can be employed by the TMC, for example. At 1802, a fund request can be received, for example, by the TMC from a communication device of the fund requestor. At 1804, the information in the fund request can be analyzed. The TMC can analyze the fund request to identify pertinent fund request information, such as the name and/or communication address of the fund requestee, the name and/or communication address of the fund requestor, the amount of funds being requested, a desired due date for providing the requested funds, a personal message from the requestor to the requestee, verification information (e.g., information that the fund requestee is to use to secure a secure token when a secure token is used), and/or other information.

At 1806, a fund request notification can be generated. The fund request notification can include all or a portion of the pertinent information identified by the TMC. The fund request notification also can comprise other information, such as one or more links that the fund requestee can select, using the fund requestee's communication device, to register with the TMC or download the MTS application, if desired. At 1808, the fund request notification can be transmitted to the communication address associated with the fund requestee.

At 1810, a response to the fund request notification can be received. For example, the response can be a fund transfer request to transfer funds from an account associated with the fund requestee/fund transferor to the fund requestor or an account associated with the fund requestor, if the fund requestee is registered with the TMC. As another example, the response can be a message comprising account information associated with the fund requestee and an authorization to withdraw funds from the fund requestee's account on a scheduled date or time, for instance, when the fund requestee is not registered with the TMC. As still another example, the response can be a fund transfer message comprising a secure token containing the funds to be transferred at the scheduled date or time, wherein the secure token or information (e.g., funds) in the secure token can be provided to the fund requestor at the scheduled date or time, wherein the fund requestee is not required to be registered with the TMC.

At 1812, funds can be transferred to the fund requestor in accordance with the response from the fund requestee. In an aspect, the TMC can process the fund transfer to facilitate transferring the funds to the fund requestor in accordance with the user preferences of the fund requestor (if the fund requestor is registered with the TMC), the user preferences of the fund requestee (if the fund requestee is registered with the TMC), and the information contained in the response (e.g., send fund transfer message to communication address of fund requestor specified in the response, transfer funds or send fund transfer message at scheduled date or time, etc.), as more fully disclosed herein.

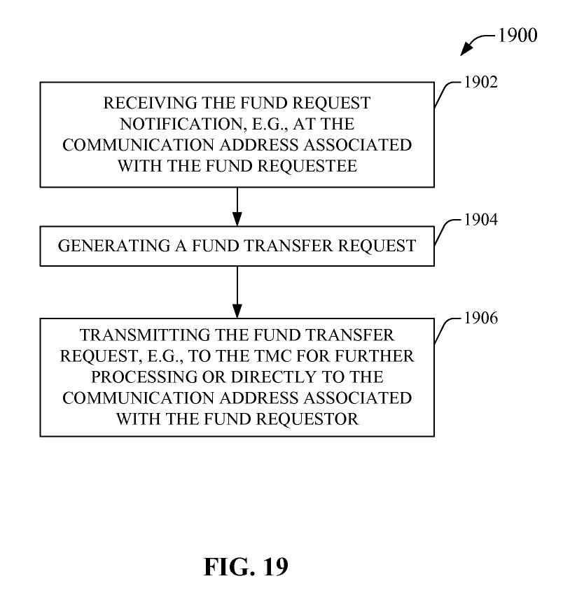

FIG. 19 presents a flow chart of an example method 1900 for transferring funds in response to a fund request in accordance with various aspects and embodiments. The method 1900 can be employed by fund requestee's communication device, for example. The fund requestee can be registered with the TMC or can be unregistered. At 1902, the fund request notification can be received, for example, at the communication address associated with the fund requestee. The fund request notification can comprise information indicating the name and/or communication address of the fund requestor, the amount of funds requested, the due date by which to pay the funds, the reason for the fund request, a personal message to the fund requestee from the fund requestor, and/or other information.

At 1904, a fund transfer request can be generated. The fund requestee/fund transferor can use the communication device to generate a fund transfer request to facilitate transferring the requested funds. The fund transfer request can comprise information, such as name and communication address of the fund requestor, name and communication address of the fund requestee, the amount of funds to be transferred, a date or time for the fund transfer to occur, account information (e.g., account number, name of financial institution, withdrawal authorization) to facilitate withdrawal of the funds from an account associated with the fund requestee (if desired), a secure token comprising the funds in electronic form (if desired), verification related information to facilitate verification of the fund requestor (if desired), and/or other information. At 1906, the fund transfer request can be transmitted, for example, to the TMC for further processing or directly to the communication address associated with the fund requestor.

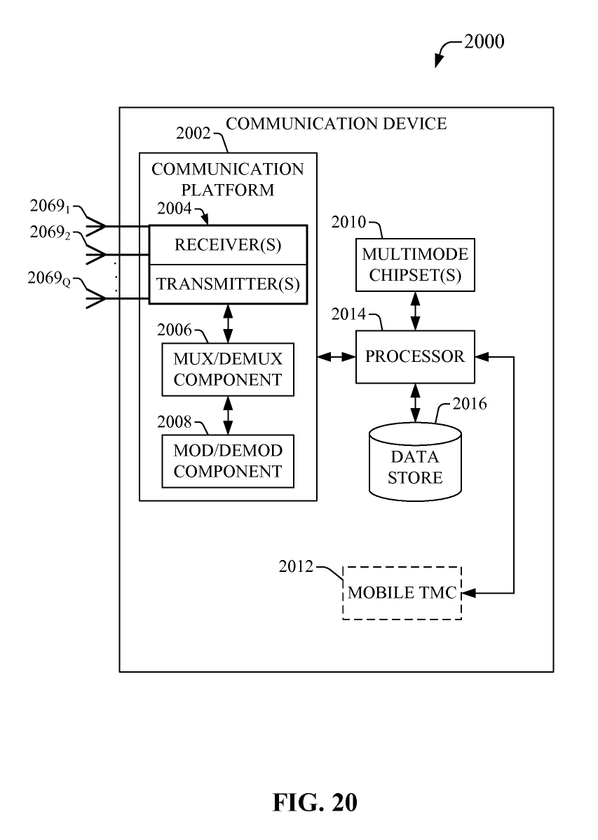

FIG. 20 depicts a block diagram of an example wireless communication device 2000 in accordance with various aspects and embodiments of the disclosed subject matter. In an aspect, the communication device 2000 can be a multimode access terminal, wherein a set of antennas 2069₁-2069_{Q} (Q is a positive integer) can receive and transmit signal(s) from and to wireless devices like access points, access terminals, wireless ports and routers, and so forth, that operate in a radio access network. It should be appreciated that antennas 2069₁-2069_{Q} are a part of communication platform 2002, which comprises electronic components and associated circuitry that provide for processing and manipulation of received signal(s) and signal(s) to be transmitted; e.g., receivers and transmitters 2004, multiplexer/demultiplexer (mux/demux) component 2006, and modulation/demodulation (mod/demod) component 2008.

In another aspect, the communication device 2000 can include a multimode operation chipset(s) 2010 that can allow the communication device 2000 to operate in multiple communication modes in accordance with disparate technical specification for wireless technologies. In an aspect, multimode operation chipset(s) 2010 can utilize communication platform 2002 in accordance with a specific mode of operation (e.g., voice, GPS). In another aspect, multimode operation chipset(s) 2010 can be scheduled to operate concurrently (e.g., when Q>1) in various modes or within a multitask paradigm.

In still another aspect, the communication device 2000 optionally (e.g., when the user is registered with the TMC, or when an unregistered user desires MTS type functions (e.g., generating a secure token, generating an MTS fund request, etc.) on the communication device 2000) can comprise a mobile TMC 2012 that can be used to facilitate generating and transmitting fund transfer request (e.g., via an MTS), receiving fund transfer messages, and obtaining funds associated with a transfer of funds, as more fully described herein. The mobile TMC 2012 can operate in conjunction with regard to a TMC of the MTS with regard to fund transfer requests or can be employed to directly send a fund transfer message (e.g., comprising a link to accept transferred funds or a secure token comprising the transferred funds or information relating thereto) to a destination (e.g., communication device, email address) of an intended recipient.

In still another aspect, the communication device 2000 also can include a processor(s) 2014 that can be configured to confer functionality, at least in part, to substantially any electronic component within the communication device 2000, in accordance with aspects of the disclosed subject matter. For example, the processor(s) 2014 can facilitate enabling the communication device 2000 to process data (e.g., symbols, bits, or chips) for multiplexing/demultiplexing, modulation/demodulation, such as implementing direct and inverse fast Fourier transforms, selection of modulation rates, selection of data packet formats, inter-packet times, etc. As another example, the processor(s) 2014 can facilitate enabling the communication device 2000 to process data relating to fund transfer requests, fund transfer messages, secure tokens, validation or authorization codes, authentication credentials, and/or other data processes relating to processing financial transactions.

The communication device 2000 also can contain a data store 2016 that can store data structures (e.g., user data, metadata); code structure(s) (e.g., modules, objects, classes, procedures) or instructions; message hashes; neighbor cell list; information relating to fund transfer requests, fund transfer messages, secure tokens, validation or authorization codes, authentication credentials, and/or other data processes relating to processing financial transactions; network or device information like policies and specifications; attachment protocols; code sequences for scrambling, spreading and pilot (e.g., reference signal(s)) transmission; frequency offsets; cell IDs; encoding algorithms; compression algorithms; decoding algorithms; decompression algorithms; and so on. In an aspect, the processor(s) 2014 can be functionally coupled (e.g., through a memory bus) to the data store 2016 in order to store and retrieve information (e.g., neighbor cell list; information relating to mobile messaging, voice calls, or other services; frequency offsets; desired algorithms; etc.) desired to operate and/or confer functionality, at least in part, to the communication platform 2002, multimode operation chipset(s) 2010, mobile TMC 2012, and/or substantially any other operational aspects of the communication device 2000.

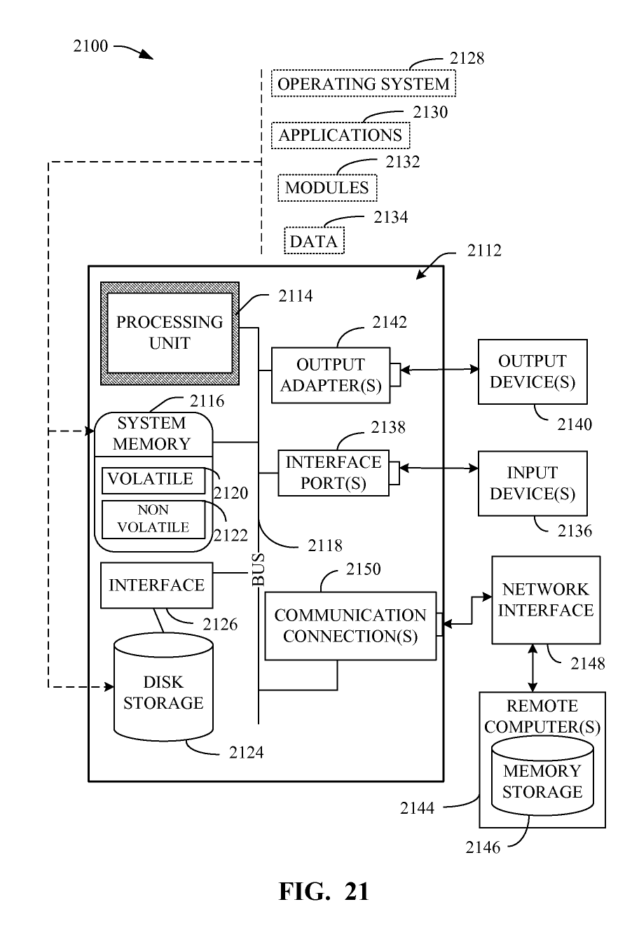

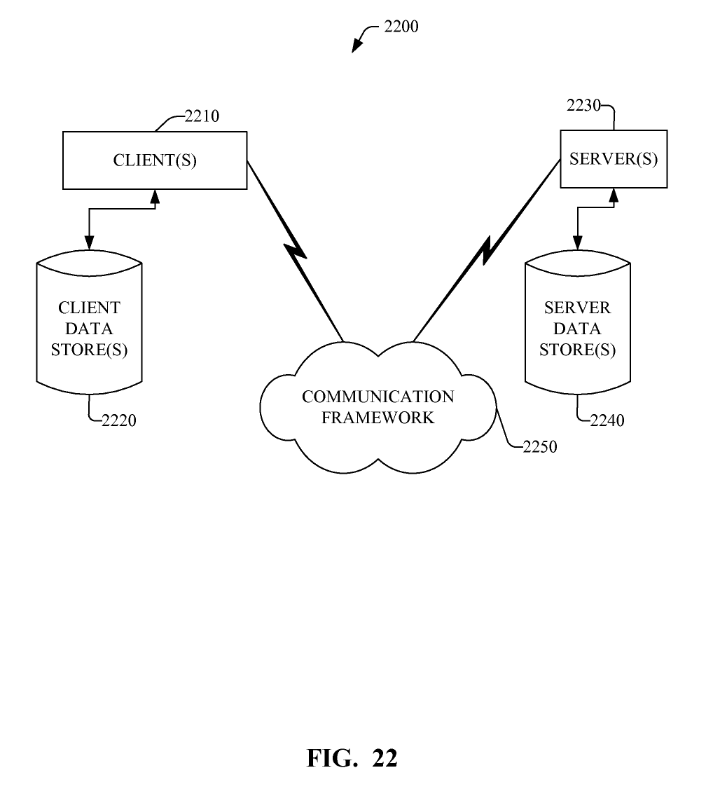

In order to provide a context for the various aspects of the disclosed subject matter, FIGS. 21 and 22 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the disclosed subject matter also can or may be implemented in combination with other program modules. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, hand-held computing devices (e.g., PDA, phone), microprocessor-based or programmable consumer or industrial electronics, and the like. The illustrated aspects may also be practiced in distributed computing environments where tasks are performed by remote processing devices that are linked through a communications network. However, some, if not all aspects of the disclosed subject matter can be practiced on stand-alone computers. In a distributed computing environment, program modules may be located in both local and remote memory storage devices.

In accordance with various aspects and embodiments, the computer (e.g., 2112) can be a communication device that can be used to generate and send fund transfer requests or messages, or receive fund transfer messages, etc.; or can comprise a TMC that can be employed to receive and process fund transfer requests, manage service accounts of MTS users, or generate and send fund transfer messages, etc.

With reference to FIG. 21, a suitable environment 2100 for implementing various aspects of the disclosed subject matter includes a computer 2112. The computer 2112 includes a processing unit 2114, a system memory 2116, and a system bus 2118. The system bus 2118 couples system components including, but not limited to, the system memory 2116 to the processing unit 2114. The processing unit 2114 can be any of various available processors. Dual microprocessors and other multiprocessor architectures also can be employed as the processing unit 2114.

The system bus 2118 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 2116 includes volatile memory 2120 and nonvolatile memory 2122. The basic input/output system (BIOS), containing the basic routines to transfer information between elements within the computer 2112, such as during start-up, is stored in nonvolatile memory 2122. By way of illustration, and not limitation, nonvolatile memory 2122 can include read only memory (ROM), programmable ROM (PROM), electrically programmable ROM (EPROM), electrically erasable programmable ROM (EEPROM), or flash memory. Volatile memory 2120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 2116 includes volatile memory 2120 and nonvolatile memory 2122. The basic input/output system (BIOS), containing the basic routines to transfer information between elements within the computer 2112, such as during start-up, is stored in nonvolatile memory 2122. By way of illustration, and not limitation, nonvolatile memory 2122 can include read only memory (ROM), programmable ROM (PROM), electrically programmable ROM (EPROM), electrically erasable programmable ROM (EEPROM), or flash memory. Volatile memory 2120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 2116 includes volatile memory 2120 and nonvolatile memory 2122. The basic input/output system (BIOS), containing the basic routines to transfer information between elements within the computer 2112, such as during start-up, is stored in nonvolatile memory 2122. By way of illustration, and not limitation, nonvolatile memory 2122 can include read only memory (ROM), programmable ROM (PROM), electrically programmable ROM (EPROM), electrically erasable programmable ROM (EEPROM), or flash memory. Volatile memory 2120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

The system memory 2116 includes volatile memory 2120 and nonvolatile memory 2122. The basic input/output system (BIOS), containing the basic routines to transfer information between elements within the computer 2112, such as during start-up, is stored in nonvolatile memory 2122. By way of illustration, and not limitation, nonvolatile memory 2122 can include read only memory (ROM), programmable ROM (PROM), electrically programmable ROM (EPROM), electrically erasable programmable ROM (EEPROM), or flash memory. Volatile memory 2120 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 2112 also includes removable/non-removable, volatile/non-volatile computer storage media. FIG. 21 illustrates, for example, a disk storage 2124. Disk storage 2124 includes, but is not limited to, devices like a magnetic disk drive, floppy disk drive, tape drive, Jaz drive, Zip drive, LS-100 drive, flash memory card, or memory stick. In addition, disk storage 2124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 2124 to the system bus 2118, a removable or non-removable interface is typically used, such as interface 2126.

It is to be appreciated that FIG. 21 describes software that acts as an intermediary between users and the basic computer resources described in the suitable operating environment 2100. Such software includes an operating system 2128. Operating system 2128, which can be stored on disk storage 2124, acts to control and allocate resources of the computer system 2112. System applications 2130 take advantage of the management of resources by operating system 2128 through program modules 2132 and program data 2134 stored either in system memory 2116 or on disk storage 2124. It is to be appreciated that the claimed subject matter can be implemented with various operating systems or combinations of operating systems.

A user enters commands or information into the computer 2112 through input device(s) 2136. Input devices 2136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2114 through the system bus 2118 via interface port(s) 2138. Interface port(s) 2138 include, for example, a serial port, a parallel port, a game port, and a universal serial bus (USB). Output device(s) 2140 use some of the same type of ports as input device(s) 2136. Thus, for example, a USB port may be used to provide input to computer 2112, and to output information from computer 2112 to an output device 2140. Output adapter 2142 is provided to illustrate that there are some output devices 2140 like monitors, speakers, and printers, among other output devices 2140, which require special adapters. The output adapters 2142 include, by way of illustration and not limitation, video and sound cards that provide a means of connection between the output device 2140 and the system bus 2118. It should be noted that other devices and/or systems of devices provide both input and output capabilities such as remote computer(s) 2144.

Computer 2112 can operate in a networked environment using logical connections to one or more remote computers, such as remote computer(s) 2144. The remote computer(s) 2144 can be a personal computer, a server, a router, a network PC, a workstation, a microprocessor based appliance, a peer device or other common network node and the like, and typically includes many or all of the elements described relative to computer 2112. For purposes of brevity, only a memory storage device 2146 is illustrated with remote computer(s) 2144. Remote computer(s) 2144 is logically connected to computer 2112 through a network interface 2148 and then physically connected via communication connection 2150. Network interface 2148 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2150 refers to the hardware/software employed to connect the network interface 2148 to the bus 2118. While communication connection 2150 is shown for illustrative clarity inside computer 2112, it can also be external to computer 2112. The hardware/software necessary for connection to the network interface 2148 includes, for exemplary purposes only, internal and external technologies such as, modems including regular telephone grade modems, cable modems and DSL modems, ISDN adapters, and Ethernet cards.

FIG. 22 is a schematic block diagram of a sample-computing environment 2200 with which the subject specification can interact. The system 2200 includes one or more client(s) 2210. The client(s) 2210 can be hardware and/or software (e.g., threads, processes, computing devices). The system 2200 also includes one or more server(s) 2230. Thus, system 2200 can correspond to a two-tier client server model or a multi-tier model (e.g., client, middle tier server, data server), amongst other models. The server(s) 2230 can also be hardware and/or software (e.g., threads, processes, computing devices). The servers 2230 can house threads to perform transformations by employing the disclosed subject matter, for example. One possible communication between a client 2210 and a server 2230 may be in the form of a data packet transmitted between two or more computer processes.

The system 2200 includes a communication framework 2250 that can be employed to facilitate communications between the client(s) 2210 and the server(s) 2230. The client(s) 2210 are operatively connected to one or more client data store(s) 2220 that can be employed to store information local to the client(s) 2210. Similarly, the server(s) 2230 are operatively connected to one or more server data store(s) 2240 that can be employed to store information local to the servers 2230.

It is to be appreciated and understood that components (e.g., communication device, communication network, TMC, mobile TMC, etc.), as described with regard to a particular system or method, can include the same or similar functionality as respective components (e.g., respectively named components or similarly named components) as described with regard to other systems or methods disclosed herein.

It is to be noted that aspects, features, and/or advantages of the disclosed subject matter can be exploited in substantially any wireless telecommunication or radio technology, e.g., Wi-Fi; Bluetooth; Worldwide Interoperability for Microwave Access (WiMAX); Enhanced General Packet Radio Service (Enhanced GPRS); Third Generation Partnership Project (3GPP) Long Term Evolution (LTE); Third Generation Partnership Project 2 (3GPP2) Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); GSM (Global System for Mobile Communications) EDGE (Enhanced Data Rates for GSM Evolution) Radio Access Network (GERAN); UMTS Terrestrial Radio Access Network (UTRAN); LTE Advanced (LTE-A); etc. Additionally, some or all of the aspects described herein can be exploited in legacy telecommunication technologies, e.g., GSM. In addition, mobile as well non-mobile networks (e.g., the Internet, data service network such as internet protocol television (IPTV), etc.) can exploit aspects or features described herein.

Various aspects or features described herein can be implemented as a method, apparatus, system, or article of manufacture using standard programming or engineering techniques. In addition, various aspects or features disclosed in the subject specification can also be realized through program modules that implement at least one or more of the methods disclosed herein, the program modules being stored in a memory and executed by at least a processor. Other combinations of hardware and software or hardware and firmware can enable or implement aspects described herein, including disclosed method(s). The term “article of manufacture” as used herein is intended to encompass a computer program accessible from any computer-readable device, carrier, or storage media. For example, computer readable storage media can include but are not limited to magnetic storage devices (e.g., hard disk, floppy disk, magnetic strips . . . ), optical discs (e.g., compact disc (CD), digital versatile disc (DVD), blu-ray disc (BD) . . . ), smart cards, and flash memory devices (e.g., card, stick, key drive . . . ), or the like.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor may also be implemented as a combination of computing processing units.

In the subject specification, terms such as “store,” “storage,” “data store,” “data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory.

By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

It is to be appreciated and understood that components (e.g., UE, AP, communication network, UE communication management component, notification communication management component, etc.), as described with regard to a particular system or method, can include the same or similar functionality as respective components (e.g., respectively named components or similarly named components) as described with regard to other systems or methods disclosed herein.

What has been described above includes examples of systems and methods that provide advantages of the disclosed subject matter. It is, of course, not possible to describe every conceivable combination of components or methods for purposes of describing the disclosed subject matter, but one of ordinary skill in the art may recognize that many further combinations and permutations of the disclosed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. A system, comprising:
a communication device associated with a money transfer service and configured to transmit a fund transfer message to a destination associated with a payee to notify the payee of a fund transfer from a payer; and
a transfer management component associated with the communication device and configured to receive a fund transfer request from a payer communication device associated with the payer, generate the fund transfer message to facilitate transfer of a specified amount of funds from an account associated with the payer to the payee, and at least one of verify the payee or associate an electronic object with the fund transfer message that requires the payee to be verified before access to the funds is granted to the payee, regardless of whether the payee is registered with the money transfer service, wherein verification information, comprising an item of authentication information that originates from the payer communication device, is transmitted in a separate message to a payee communication device from the payer communication device to facilitate the verification of the payee based at least in part on the item of authentication information.

2. The system of claim 1, wherein the transfer management component is further configured to provide an application to the payer communication device associated with the payer to enable the payer communication device to generate the transfer fund request in a money-transfer-service format.

3. The system of claim 1, wherein the destination is a message in-box associated with a communication address associated with the payee and accessible via the payee communication device associated with the payee, and wherein the transfer management component is further configured to insert one or more links in the fund transfer message, wherein the one or more links are selectable to at least one of access an online verification page via the payee communication device to facilitate verification of the payee, access an online registration page via the payee communication device to facilitate registration of the payee with the transfer management component, or access an online application download page via the payee communication device to facilitate download of an application to the payee communication device.

4. The system of claim 3, wherein the transfer management component is further configured to receive a subset of verification information from the payee communication device in relation to the fund transfer message, and analyze the subset of verification information to facilitate determination of whether the payee is verified.

5. The system of claim 4, wherein the subset of verification information comprises at least one communication address associated with the payee, the communication address is at least one of a phone number or an email address, associated with the payee.

6. The system of claim 5, wherein the transfer management component is further configured to transmit a verification code to the at least one communication address in response to receipt of the subset of verification information and a request for a verification code from the payee communication device.

7. The system of claim 6, wherein the transfer management component is further configured to receive another portion of the subset of verification information comprising a payee-provided verification code as submitted by the payee communication device, compare the payee-provided verification code to the verification code transmitted to the at least one communication address, and allow access to the funds associated with the fund transfer message in response to verification that the payee-provided verification code matches the verification code or deny access to the funds associated with the fund transfer message in response to determination that the payee-provided verification code does not match the verification code.

8. The system of claim 1, wherein the transfer management component is further configured to at least one of verify the payee, or generate the electronic object and associate the electronic object with the fund transfer message, and the electronic object is a secure token comprising the funds associated with the fund transfer represented as an electronic structure.

9. The system of claim 8, wherein the transfer management component is further configured to at least one of verify the payee or associate the electronic object with the fund transfer message, and, if the transfer management component associates the electronic object with the fund transfer message, the transfer management component is further configured to at least one of encrypt data associated with the secure token or lock the secure token, based at least in part on a subset of the verification information, comprising the secret information, in accordance with a predefined cryptographic protocol.

10. The system of claim 1, wherein the transfer management component is further configured to receive a message comprising a fund request from a fund requestor communication device associated with a fund requestor, wherein the fund request requests funds from a fund requestee associated with a communication address specified in the fund request.

11. The system of claim 10, wherein the transfer management component is further configured to generate a fund request notification comprising at least one of a name of the fund requestor, a communication address associated with the fund requestor, a name of the fund requestee, a communication address associated with the fund requestee, an amount of funds requested, a date by which the funds are to be submitted to the fund requestor, or a personal message, and transmit the fund request notification to the communication address associated with the fund requestee.

12. The system of claim 11, wherein the transfer management component is further configured to receive a fund transfer request from a fund requestee communication device associated with the fund requestee in response to the fund request notification.

13. The system of claim 12, wherein the fund transfer request comprises at least one of account information associated with the fund requestee or a secure token.

14. A method, comprising:
transmitting, by a system including a processor, a fund transfer message to a communication address associated with an intended recipient of funds associated with the fund transfer message, notwithstanding registration status of the intended recipient with a transfer management component that is managing a fund transfer associated with the fund transfer message, wherein verification information, comprising an item of authentication information that originates from a payer communication device, is transmitted in a separate message to an intended-recipient communication device from the payer communication device to facilitate verification of the intended recipient based at least in part on the verification information, and the payer communication device is associated with a payer initiating the fund transfer to the intended recipient; and
controlling, by the system, access to the funds by the intended recipient associated with the fund transfer message based at least in part on the verification information, comprising the item of authentication information, associated with the fund transfer.

15. The method of claim 14, further comprising:
receiving a first subset of verification information, comprising an intended-recipient-provided communication address, from the intended-recipient communication device, in response to the fund transfer message;
verifying the first subset of verification information by comparing the intended-recipient-provided communication address to the communication address associated with the fund transfer message to determine whether there is a match; and
transmitting a verification code to the communication address associated with the intended recipient in response to determining the intended-recipient-provided communication address matches the communication address associated with the fund transfer message.

16. The method of claim 15, further comprising:
receiving a second subset of verification information, comprising an intended-recipient-provided verification code;
verifying the second subset of verification information by comparing the intended-recipient-provided verification code to the verification code to determine whether there is a match; and
granting access to the funds to the intended recipient in response to verifying the first subset of verification information and the second subset of verification information.

17. The method of claim 14, further comprising:
receiving a message comprising a fund request that requests funds from a third party, wherein the message is received from a communication device associated with a fund requestor;
generating a fund request notification comprising information relating to the fund request; and
transmitting the fund request notification to a communication address associated with the third party.

18. The method of claim 17, further comprising:
at least one of:
receiving a fund transfer request, comprising account information, from the communication device associated with the third party, wherein the fund transfer request requests that the funds be transferred to a fund requestor, and wherein the account information comprises at least one of an account number for an account associated with the third party, an authorization to withdraw the funds from the account, or a date to execute the fund transfer, or
receiving a fund transfer request, comprising a secure token, from the communication device associated with the third party, wherein the fund transfer request requests that the funds be transferred to a fund requestor, and wherein the secure token comprises the funds represented in an electronic structure or information that facilitates accessing the funds.

19. The method of claim 18, further comprising:
generating a fund transfer notification, comprising information relating to the fund transfer request; and
transmitting the fund transfer notification to a communication address associated with the fund requestor to facilitate enabling the fund requestor to access the funds at a scheduled date associated with the fund transfer request.

20. The method of claim 14, further comprising:
providing an application to a communication device associated with the intended recipient, wherein the application facilitates generating of a secure token by the communication device, and wherein the secure token comprises the funds represented in an electronic form or information relating to the funds.

21. A computer program product comprising a computer readable storage medium comprising computer executable instructions that, in response to execution, cause a system including a processor to perform operations, comprising:
transmitting a fund transfer message to a communication address associated with a payee in relation to funds associated with the fund transfer message irrespective of a registration status of the payee with a transfer management component managing a fund transfer associated with the fund transfer message, wherein verification information, comprising an item of authentication information that originates from a payer communication device, is transmitted in a separate message to the communication address associated with the payee from the payer communication device to facilitate verification of the payee based at least in part on the verification information, the payee is one of registered with the transfer management component or not registered with the transfer management component, and the payer communication device is associated with a payer initiating the fund transfer to the payee; and
controlling access to the funds by the payee associated with the fund transfer message based at least in part on the verification information, comprising the item of authentication information.

22. A communication device, comprising:
a user interface configured to display information relating to a transfer of funds facilitated by a money transfer service; and
a message component configured to receive verification information, comprising an item of authentication information that originates from the payer communication device, via a message from a payer communication device and provide the verification information, comprising the item of authentication information, to facilitate verification of a user associated with the communication device to facilitate access to the funds by the user upon being verified, regardless of whether the user is registered with the money transfer service, wherein the user is one of registered with the money transfer service or not registered with the money transfer service, and the payer communication device is associated with a payer requesting the transfer of funds to the user.

23. The communication device of claim 22, wherein the verification information comprising at least one of a communication address associated with the user or a verification code received from the money transfer service.

24. The communication device of claim 22, wherein the message component is further configured to receive selection of a link contained in a fund transfer message received by the communication device, wherein the link facilitates access to an online verification page associated with the money transfer service to facilitate submission of the verification information to the money transfer service via the online verification page.

25. The communication device of claim 22, further comprising:
a mobile transfer management component configured to generate a secure token comprising funds represented as data to facilitate transfer of the funds to an other communication device, wherein at least one of the secure token is locked or the data within the secure token is encrypted, in accordance with a predefined cryptographic protocol; and transmit the secure token to the other communication device.

26. The system of claim 1, wherein the payee is not registered with the money transfer service.

27. The system of claim 1, wherein the payee is registered with the money transfer service.

28. The method of claim 14, wherein the intended recipient is one of registered with the transfer management component or not registered with the transfer management component.

29. The system of claim 1, wherein the transfer management component receives the item of authentication information from the payer communication device to facilitate enabling the transfer management component to use the item of authentication information to facilitate the verification of the payee.
